(19) United States
(12) Patent Application Publication
(10) Pub. No.: US 2013/0185003 A1
(43) Pub. Date: Jul. 18, 2013

(54) DETECTION OF A FORCE ON A FOOT OR FOOTWEAR

(71) Applicants: Jeffrey Carbeck, Belmont, MA (US); Kevin Dowling, Westford, MA (US); David Icke, Weston, MA (US); Ben Schlatka, Lexington, MA (US); Steven Fastert, Chelmsford, MA (US)

(72) Inventors: Jeffrey Carbeck, Belmont, MA (US); Kevin Dowling, Westford, MA (US); David Icke, Weston, MA (US); Ben Schlatka, Lexington, MA (US); Steven Fastert, Chelmsford, MA (US)

(73) Assignee: MC10, Inc.

(21) Appl. No.: 13/550,254

(22) Filed: Jul. 16, 2012

Related U.S. Application Data
(60) Provisional application No. 61/507,942, filed on Jul. 14, 2011.

(51) Int. Cl. A43B 3/00; G01L 1/00

(52) U.S. Cl. CPC A43B 3/0005; G01L 1/00
USPC 702/41

(57) ABSTRACT

A system is provided for monitoring a force acting on a foot or a footwear. The system includes an assembly that is disposed proximate to a region of the foot or the footwear. The assembly includes a sensing device and a processor communicatively coupled to the sensing device. The sensing device is disposed on a flexible substrate or a stretchable substrate, where the sensing device conforms to the region of the foot or the footwear, and where the sensing device is used to measure data relating to the force acting on the foot or the footwear. The processor executes processor-executable instructions to analyze the data from the sensing device. The analysis can be used to provide an indication of the measured force.

### CROSS-REFERENCES TO RELATED APPLICATIONS

This application claims priority U.S. provisional application Ser. No. 61/507,942, filed Jul. 14, 2011, entitled “Method and Sensor for Detecting Impact Location and Magnitude,” which is hereby incorporated herein by reference in its entirety.

### BACKGROUND

The action of a force on a foot potentially can cause injury. Such a force can be exerted by motion of an individual while walking or running, or can be exerted by an object impacting the foot (such as falling on the foot). Examples of forces that could potentially cause injury include a translation or rotational motion, or a sudden change in motion, including an acceleration and/or change in orientation, of the foot. These forces can act on a foot in the course of activities such as in connection with occupational activities, military exercises, (e.g., training, combat), or sport-related activities.

For example, in a workplace environment such as a construction site, a worker's foot may be impacted by falling debris, construction materials, or construction equipment. Other activities such as jumping or dancing can cause excessive forces to be exerted on the foot. Any of the foregoing illustrative situations may result in some degree of injury to the person.

In addition, an analysis of the gait, including heel strike or toe strike, can be used during a therapy, including physical therapy or occupational therapy, to prevent further injury.

### SUMMARY

In view of the foregoing, the Inventors have recognized and appreciated that both sufficient comfort and accuracy are desirable attributes of techniques for sensing impact to a foot or footwear. Regarding sensing impact to a foot or footwear, including its magnitude or its location (e.g., resulting from a force exerted on or in proximity to the foot), the Inventors have provided methods and systems for detecting such impacts.

Accordingly, an example system and method according to the principles herein provide a device configuration that can be used to measure a force from an impact to the foot and/or footwear during an activity. The system includes at least one device configuration. A device configuration can include one or more sensing devices for measuring data relating to a force acting on the foot or the footwear and a processor communicatively coupled to the sensing device. The processor can be configured to execute processor-executable instructions to analyze the data from the sensing device. The analysis can be used to provide an indication of the measured force acting on the foot or footwear.

An indication of a measured force can include providing at least one of a magnitude of the measured force and/or an indication of a location of action of the measured force at a plurality of locations of the foot or the footwear.

A sensing devices according to the principles herein can be disposed on a flexible substrate or a stretchable substrate. The device configuration can be coupled to the foot and/or footwear, including being mechanically coupled to the foot or footwear. Also, any of the sensing devices described herein can be configured to conform to the region of the foot or the footwear.

An example system for monitoring a force acting on a foot or a footwear can include an assembly disposed proximate to a region of the foot or the footwear. The assembly can include a sensing device that includes a single accelerometer and a processor communicatively coupled to the sensing device. The sensing device can be disposed on a flexible substrate or a stretchable substrate and the sensing device conforms to the region of the foot or the footwear. The sensing device measures data relating to a force acting on the foot or the footwear. The processor executes processor-executable instructions to analyze the data from the sensing device, where the analysis provides an indication of a location of action of the measured force at a plurality of locations of the foot or the footwear.

In an example, the accelerometer can be a triple-axis accelerometer, where measuring the data relating to the force, and where the processor-executable instructions include instructions to compute a projection of the measurement of the accelerometer at the plurality of locations.

In an example, the sensing device can be a low-G accelerometer, where the processor further executes processor-executable instructions to compute data relating to the force acting on the foot or the footwear that can be not measured using the low-G accelerometer. In this example, the processor-executable instructions may include instructions to perform a linear interpolation or a curve fitting to compute data relating to the force acting on the foot or the footwear that can be not measured using the low-G accelerometer.

In an example, the sensing device can be a low-G, triple-axis accelerometer, where the processor-executable instructions include instructions to perform a linear interpolation or a curve fitting to compute data relating to the force acting on the foot or the footwear that can be not measured using the low-G, triple-axis accelerometer.

This example system can further include a gyroscope. The gyroscope can measure data relating to at least one of a location of action of the force and a magnitude of the force on the foot or footwear. In an example according to this principle, the processor can further execute processor-executable instructions to analyze the data from the gyroscope, where the analysis provides an indication of at least one of the location of action of the force and the magnitude of the force. In another example according to this principle, the gyroscope can measure an angular rotation of the foot or footwear based on the action of the force, where the processor-executable instructions include instructions to analyze the data to provide an indication of whether the force can be acting at a heel region or a toe region of the foot or footwear.

This example system can further include a transmitter. The transmitter can transmit to a display the indication of the location of action of the measured force at the plurality of locations of the foot or the footwear. In an example according to this principle, the transmitter further transmits the data from the sensing device to the display, wherein a processor associated with the display executes processor-executable instructions to analyze the data from the sensing device and the indication of the location of action of the measured force at the plurality of locations of the foot or the footwear, and wherein the analysis provides an additional indication of the location of action of the measured force at the plurality of locations of the foot or the footwear.

In an example, the system can further include a memory communicatively coupled to the processor to store at least one of the processor-executable instructions, the measured data relating to the force acting on the foot or the footwear, and the indication of the location of action of the measured force at the plurality of locations of the foot or the footwear.

In an example, the system can further include a display to display the indication of the location of action of the measured force at the plurality of locations of the foot or the footwear, and wherein the display can be a screen of a hand-held device, a liquid crystal display, a screen of a computing device, or a light emitting diode.

In an example, the system can further include at least one flexible and/or stretchable interconnect to couple the sensing device to the processor.

Another example system for monitoring a force acting on a foot or a footwear can include an assembly disposed proximate to a region of the foot or the footwear, where the assembly includes an array of conformal sensing devices and a processor communicatively coupled to at least one of the conformal sensing devices of the array. The array of conformal sensing devices conforms to the region of the foot or the footwear, and the array of conformal sensing devices can measure data relating to a force acting on the foot or the footwear. The processor executes instructions to analyze the data from the conformal sensing devices, where the analysis provides an indication of the measured force.

In an example, the processor executes processor-executable instructions to compute data relating to a magnitude of the force acting on the foot or the footwear.

In an example, the system further includes a transmitter to transmit the data from the sensing device to a display, where a processor of the remote display executes processor-executable instructions to analyze the data from the sensing device, and where the analysis provides an additional indication of the measured force.

In an example, the system can further including a transmitter, where the transmitter transmits to a display the indication of the measured force. In an example according to this principle, the transmitter can further transmit the data from the sensing device to the display, where a processor associated with the display executes processor-executable instructions to analyze the data from the sensing device and the indication of the measured force, and where the analysis provides an additional indication of the measured force.

In an example, the system can further include a memory communicatively coupled to the processor to store at least one of the processor-executable instructions, the measured data relating to the force acting on the foot or the footwear, and the indication of the measured force.

In an example, the system can further include a display to display the indication of the measured force, and wherein the display can be a screen of a hand-held device, a liquid crystal display, a screen of a computing device, or a light emitting diode.

In an example, the system can further include at least one flexible and/or stretchable interconnect to couple at least one conformal sensing device of the array of conformal sensing devices to the processor.

Another example system for monitoring a force acting on a foot or a footwear can an assembly disposed proximate to a region of the foot or the footwear, where the assembly includes a sensing device including a pressure sensitive rubber and a processor communicatively coupled to the sensing device. The sensing device conforms to the region of the foot or the footwear, and the sensing device can measure data relating to a force acting on the foot or the footwear. The processor executes processor-executable instructions to analyze the data from the pressure sensitive rubber, where the analysis provides an indication of the measured force.

In an example, the analysis provides an indication of at least one of a location of action of the force and a magnitude of the force.

In an example, the processor-executable instructions include instructions to compare the measured data to a calibration standard.

In an example, the calibration standard can be generated by applying a plurality of known forces to a plurality of locations around a modeled foot or footwear, measuring the response of the sensing device to the known forces, and correlating values of the known magnitude of the known forces to the measured response of the sensing device.

In an example, the system can further include a transmitter to transmit the measured data to a display, where a processor of the remote display executes processor-executable instructions to further analyze the data from the sensing device, and where the further analysis provides an additional indication of the measured force.

In an example, the system can further include a transmitter, wherein the transmitter transmits to a display the indication of the measured force. In an example, the transmitter further transmits the data from the sensing device to the display, where a processor associated with the display executes processor-executable instructions to analyze the data from the sensing device and the indication of the measured force, and where the analysis provides an additional indication of the measured force.

In an example, the system further includes a memory communicatively coupled to the processor to store at least one of the processor-executable instructions, the measured data relating to the force acting on the foot or the footwear, and the indication of the measured force.

In an example, the system further includes a display to display the indication of the measured force, where the display can be a screen of a hand-held device, a liquid crystal display, a screen of a computing device, or a light emitting diode.

In an example, the system further includes at least one flexible and/or stretchable interconnect to couple the sensing device to the processor.

Another example system for monitoring a force acting on a foot or a footwear includes an assembly disposed proximate to a region of the foot or the footwear, where the assembly includes a sensing device including an array of touch elements and a processor communicatively coupled to at least one of the touch elements of the array. The sensing device conforms to the region of the foot or the footwear, wherein the sensing device can measure data relating to a force acting on the foot or the footwear. The processor executes processor-executable instructions to analyze the data from the touch elements, where the analysis provides an indication of the measured force.

In an example, the analysis provides an indication of at least one of a location of action of the force and a magnitude of the force.

In an example, the system can further include a transmitter to transmit the measured data to a display, where a processor of the remote display executes processor-executable instructions to further analyze the data from the sensing device, and where the analysis provides an additional indication of the measured force.

In an example, the system further includes a transmitter, where the transmitter transmits to a display the indication of the measured force. In an example according to this principle, the transmitter may further transmits the data from the sensing device to the display, where a processor associated with the display executes processor-executable instructions to analyze the data from the sensing device and the indication of the measured force, and where the analysis provides an additional indication of the measured force.

In an example, the system further includes a memory communicatively coupled to the processor to store at least one of the processor-executable instructions, the measured data relating to the force acting on the foot or the footwear, and the indication of the measured force.

In an example, the system further includes a display to display the indication of the measured force, where the display can be a screen of a hand-held device, a liquid crystal display, a screen of a computing device, or a light emitting diode.

In an example, the system further includes a display, wherein the processor executes processor-executable instructions to cause the display to display the indication of the measured force.

In an example, the system further includes at least one flexible and/or stretchable interconnect to couple at least one touch element of the array of touch elements to the processor.

Also provided herein is an insert for a footwear that includes a system according to any of the principles herein, including any of the systems described herein. In an example, the insert may be a sock or a sticker.

Also provided herein is a footwear that includes at least one of the systems according to any of the principles herein, including any of the systems described herein. The sensing device of the system can measure a force acting on a foot or the footwear during the course of a physical therapy, an occupational therapy, a military activity, a biomechanics measurement, or an industrial activity.

Another example system for monitoring a force acting on a foot or a footwear includes an assembly disposed proximate to a region of the foot or the footwear, where the assembly includes a sensing device that includes a single accelerometer and a processor communicatively coupled to the sensing device. The sensing device can measure data relating to a force acting on the foot or the footwear. The processor executes processor-executable instructions to analyze the data from the sensing device, and the analysis provides an indication of a location of action of the measured force at a plurality of locations of the foot or the footwear.

In an example, the accelerometer can be a triple-axis accelerometer, where measuring the data relating to the force, and where the processor-executable instructions include instructions to compute a projection of the measurement of the accelerometer at the plurality of locations.

In an example, the sensing device can be a low-G accelerometer, where the processor further executes processor-executable instructions to compute data relating to the force acting on the foot or the footwear that can be not measured using the low-G accelerometer.

In an example, the processor-executable instructions may include instructions to perform a linear interpolation or a curve fitting to compute data relating to the force acting on the foot or the footwear that can be not measured using the low-G accelerometer.

In another example, the sensing device can be a low-G, triple-axis accelerometer, where the processor-executable instructions include instructions to perform a linear interpolation or a curve fitting to compute data relating to the force acting on the foot or the footwear that can be not measured using the low-G, triple-axis accelerometer.

In an example, the system can further include a gyroscope, where the gyroscope measures data relating to at least one of a location of action of the force and a magnitude of the force on the foot or footwear. In an example according to this principle, the processor may further executes processor-executable instructions to analyze the data from the gyroscope, where the analysis provides an indication of at least one of the location of action of the force and the magnitude of the force.

In an example, the gyroscope can measure an angular rotation of the foot or footwear based on the action of the force, where the processor-executable instructions include instructions to analyze the data to provide an indication of whether the force can be acting at a heel region or a toe region of the foot or footwear.

In an example, the system can further include a transmitter, where the transmitter transmits to a display the indication of the location of action of the measured force at the plurality of locations of the foot or the footwear.

In an example, the transmitter can further transmits the data from the sensing device to the display, where a processor associated with the display executes processor-executable instructions to analyze the data from the sensing device and the indication of the location of action of the measured force at the plurality of locations of the foot or the footwear, and where the analysis provides an additional indication of the location of action of the measured force at the plurality of locations of the foot or the footwear.

In an example, the system further includes a memory communicatively coupled to the processor to store at least one of the processor-executable instructions, the measured data relating to the force acting on the foot or the footwear, and the indication of the location of action of the measured force at the plurality of locations of the foot or the footwear.

In an example, the system further includes a display to display the indication of the location of action of the measured force at the plurality of locations of the foot or the footwear, where the display can be a screen of a hand-held device, a liquid crystal display, a screen of a computing device, or a light emitting diode.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein. It should also be appreciated that terminology explicitly employed herein that also may appear in any disclosure incorporated by reference should be accorded a meaning most consistent with the particular concepts disclosed herein.

The foregoing and other aspects, examples, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIGS. 1A-1C shows block diagrams of example systems for measuring a force acting on a foot or footwear, according to the principles herein.

FIGS. 2A-2E show example device configurations for measuring a force acting on a foot or footwear disposed at various locations, according to the principles herein.

FIG. 3 shows a block diagram of an example system for measuring a force acting on a foot or footwear, according to the principles herein.

FIG. 4 is a block diagram of an example system that includes an accelerometer, according to the principles herein.

FIG. 5 is a block diagram of an example system that includes an accelerometer and gyroscope, according to the principles herein.

FIGS. 6A-6C show example device configurations for measuring a force acting on a foot or footwear disposed at various locations, according to the principles herein.

FIG. 7 shows a block diagram of an example system that includes an array of sensors, according to the principles herein.

FIG. 8 is an illustration of the placement of a pressure sensitive rubber sensor for identifying the location and magnitude of a force applied to a foot, according to the principles herein.

FIG. 9 is a block diagram of an example system that includes a pressure sensitive rubber sensor, according to the principles herein.

FIGS. 10A-10C show block diagrams of different example microcontroller configurations, according to the principles herein.

FIG. 11A-11B is a block diagram illustrating a plurality of display unit configurations for displaying information to a user, according to the principles herein.

FIG. 12 is a block diagram illustrating the configuration of a sensor module, according to the principles herein.

FIG. 13 is a flow chart illustrating an example method of providing an indication of a force acting on a foot or footwear, according to the principles herein.

### DETAILED DESCRIPTION

Following below are more detailed descriptions of various concepts related to, and examples of, methods and apparatus for conformal sensing of force and/or change in motion. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but not limited to, the term “including” means including but not limited to. The term “based on” means based at least in part on.

An example system and method according to the principles herein provide a device configuration that can be used to assess (including to quantify) impact to the foot and/or footwear during various activities. A device configuration described herein can include one or more sensing devices for measuring data relating to a force acting on the foot or the footwear and a processor communicatively coupled to the sensing device. The processor can be configured to execute processor-executable instructions to analyze the data from the sensing device. The analysis provides an indication of the measured force acting on the foot or footwear. Such an indication can include providing at least one of a magnitude of the measured force and/or an indication of a location of action of the measured force at a plurality of locations of the foot or the footwear (such as but not limited to an indication of whether the force is acting at a heel region or a toe region of the foot or footwear).

Any of the sensing devices described herein can be disposed on a flexible substrate or a stretchable substrate. The device configuration can be coupled to the foot and/or footwear, including being mechanically coupled to the foot or footwear. Also, any of the sensing devices described herein can be configured to conform to the region of the foot or the footwear.

In one example, the device configuration can be configured as a single integrated assembly that includes the various sensors or other measurement device. The single integrated assembly can be disposed at any position relative to the foot or footwear. In another example, the device configuration can be configured into a multi-component assembly that includes the various sensors. For example, each different component of the multi-component assembly can include a different type of sensor or other measurement device. As another example, one or more of the components of the multi-component assembly can include a same type of sensor or other measurement device. One or more components of the multi-component assembly can be disposed in close proximity at a position relative to the foot or footwear, or can be disposed in a spaced apart arrangement at different positions on the foot or footwear. For example, the device configuration can be a multi-component assembly, where different components are disposed at the heel, at or near the ball of the foot, outside or near the arch of the foot (whether on the foot or on the footwear). In another example, different components of a multi-component assembly can be disposed in proximity to the toes.

The impact or forces measured according to principles herein can be any force that acts on a foot or footwear during the course of an activity. In an example, the activity can include physical therapy, occupational therapy, military activity, industrial activity (including construction work), activity performed in a biomechanics measurement, or sports-related activity. For example, the impact or force can be exerted when the foot or footwear makes contact with a surface (including the ground, a pedal of a vehicle, an exercise bike, a treadmill or other similar equipment). In another example, the impact or force can be exerted when the foot or footwear makes contact with an object, including an object that falls on the foot or footwear (e.g., at a construction site or during a sport). Any of the example systems described herein can be used to monitor the impact of a foot or footwear during a walking or running motion during the course of an activity. Any of the example systems and methods herein can be used to analyze data from the measurements made by the device configuration to provide an indication of the magnitude and/or direction of forces acting on the foot and/or footwear.

In any example herein, reference to a foot of a human can be considered to apply to a paw or hoof or a non-human animal. Therefore, various examples of the systems and methods described herein relative to a foot and/or footwear also can be applicable to non-human animals.

In various examples described herein, a device configuration according to principles herein can include at least one accelerometer. The measurements of the accelerometer can be used to indicate a change in motion of the foot and/or footwear. For example, a change in motion may refer to one or more of an acceleration (i.e., a change in velocity), a change in orientation, a vibration shock, and a falling process. An accelerometer can be configured to sense various changes in motion along one or more axes. An accelerometer can provide an output signal representative of a “g-force” acting on an object (e.g., a “g-force” can be an object's acceleration relative to free-fall due to the vector sum of non-gravitational forces acting on the object). A g-force (denoted herein by the unit g) can causes stresses and strains on an object. Large g-forces may be destructive. Some types of commercially available accelerometers, including “commercial off-the-shelf” or “COTS,” accelerometers may include piezoelectric or capacitive components to convert mechanical motion into an electrical signal. A piezoelectric accelerometer may exploit properties of piezoceramic materials or single crystals for converting mechanical motion into an electrical signal. Capacitive accelerometers can employ a silicon micro-machined sensing element, such as a micro-electrical-mechanical system, or MEMS, sensing element.

In an example, the accelerometer can be used to measure the static angle of tilt or inclination of portions of the foot. For example, an angle of inclination of a portion of a foot can be computed based on the output of the accelerometer. In another example, the inclination sensing can use a measure of the acceleration vector of the impact on the foot, and its projection on a pre-defined axis system (such as but not limited to the axes of the accelerometer), to determine the tilt angle. The projection can be determined as a vector sum analysis of the output of the accelerometer.

In some examples of systems and methods according to principles described herein, the example device configuration can include at least one microcontroller. The at least one microcontroller can include at least one processor that is configured to execute processor-executable instructions for assessing (or otherwise quantifying) the impact on portions of the foot based on an analysis of the measurements of the devices of the device configuration (as described herein). The processor-executable instructions can include software and/or algorithms which, when executed, perform the analysis of the measurements of the device configuration. The processor-executable instructions can by stored on a memory of the system.

In other examples of systems and methods according to principles described herein, the analysis of the measurements made by the example device configuration can performed partially using a microcontroller of the system and partially using a processor of an external device that is configured to receive and analyze data from the system (as described herein). For example, a processor of the microcontroller can configured to execute processor-executable instructions to provide a partial analysis of the sensor measurements to provide some parameters indicative of the force of the impact. The processor of the external device can be configured to execute processor-executable instructions to receive and analyze data from the system to provide parameters indicative of the force of the impact, either by further analyzing the partially-analyzed data from the system or by further analyzing the partially-analyzed data from the system and a portion of the measurements of the device configuration.

In one aspect, the example device configuration and processor-executable instructions can facilitate identifying what portion of a foot is striking (or otherwise making contact with) a surface when a subject is standing or during running, jogging, walking or other movement during the course of various activities. In one example, the device configuration and processor-executable instructions can be used to identify heel strikes versus toe strikes when a wearer is running, jogging, walking, or engaging in other movement of the foot.

In an example system and method, the device configuration can include a single three-axis accelerometer to identify the location of the strike or other impact on the foot. In another example system and method, the device configuration can include an array of pressure sensors embedded in the sole of a shoe. The array of pressure sensors can include at least one pressure sensor, at least two pressures sensors, or more, up to any number of pressure sensors. The device configurations described herein can be integrated at various locations in footwear, can be incorporated in a sock, or other foot covering, that can be worn with or without shoes. In another example, the device configurations described herein can be applied, or otherwise adhered to, a foot or to the footwear. For example, the device configuration can be adhered using an adhesive (such as a sticker or patch), or using a hook and loop fastener, a burr fastener, or a touch fastener (including using VELCRO® (Velcro USA Inc., Manchester, N.H.)). The accelerometer can be a single-axis, a dual-axis, or a triple-axis accelerometer. In a non-limiting example, the device configuration can include at least one triple-axis accelerometer. In another example, the device configuration can include a low-g accelerometer to reduce the costs of the system. In a non-limiting example, the low-g accelerometer is in a low-g range of less than or about 20 g.

In another example, the device configuration can include at least one accelerometer and at least one gyroscope. A gyroscope can facilitate the determination of refined location and magnitude detection. As a non-limiting example, a gyroscope can be used for determining the tilt or inclination of a portion of a foot and/or footwear. For example, the tilt or inclination can be computed based on integrating the output (i.e., measurement) of the gyroscope.

In an example, a device configuration described herein can include at least portion of a pressure sensitive rubber (such as but not limited to a mat of pressure sensitive rubber). In another example, a device configuration described herein can include at least one array of conformal contact sensors and/or pressure sensors. The array of conformal contact sensors and/or pressure sensors can include at least one conformal contact sensor and/or at least one pressure sensor, at least two conformal contact sensors and/or at least two pressure sensors, or more, up to any number of conformal contact sensors and/or pressure sensors.

In yet another example, a device configuration described herein can include at least one array of capacitive sensors (including capacitive touch pads). For example, the array of capacitive sensors can include an array of touch elements, where a processor is coupled to at least one of the touch elements of the array. The capacitive touch elements may provide a measure of a force if there is a change in capacitance of at least one touch element. For example, contact of one or more touch elements by a portion of a foot may cause a change in an electrical property of the touch element or may cause a change in physical separation of a portion of the touch elements. Either mechanism can result in a change of an effective capacitance of the one or more touch element that can be detected to provide a measurement of a force. The array of capacitive sensors can include at least one capacitive sensor, at least two capacitive sensors, or more, up to any number of capacitive sensors.

In a non-limiting example, the device configurations described herein can include one or more of these other sensing modalities in place of or in combination with the at least one accelerometer, including one or more contact sensors based on a pressure sensitive rubber, a capacitive sensor, a conformal contact sensor, or other type of pressure sensor.

According to principles herein, an analysis of the data from the device configuration is used to provides an indication of the force acting on the foot and/or footwear. For example, the data from the device configuration can be processed to provide an indication of running and/or walking style. As another example, the data from the device configuration can be analyzed for the purpose of training and/or improving walking or running during activities such as but not limited to physical therapy, occupational therapy, military activities, industrial activities, activities performed in a biomechanics measurement, and sports-related activities. In an example, the indication of the force may include quantitative information about the force acting on the foot and/or footwear. In an example, the signal differential from different portions or components of the device configuration can be analyzed to quantify a measure of the impact at each portion of the device configuration, or at portions of the foot or footwear. In another example, the indication of the force may include quantitative information about heel strike data and/or toe strike data. In another example, the indication of the force can include an indication of overpronation, rotation, excess braking, or movement that goes beyond threshold bounds (e.g., too much movement up and/or down beyond threshold limits). In another example, the indication of the force may include an identification of suggested changes and/or improvements to the gait and/or style of the walking or running. In yet other examples, the data from the device configuration can be analyzed to provide statistical information including averages or median values of the force acting on various portions of a foot or footwear.

In an example, the measurement of the device configuration and/or the analysis of the data from the device configuration is stored in a memory of the system. Longer-term storage of the quantitative information can be used to identify trends of the force acting on the foot and/or footwear or to indicate a performance over time of a subject based on the quantified force acting on the subject's foot and/or footwear.

According to principles herein, the measurement of the device configuration and/or the analysis of the data from the device configuration can be stored and/or displayed to a display to provide a visual indication of the force acting on the foot and/or footwear. The display can be, but is not limited to, such devices as a computer, a watch or other display mounted to a portion of the body, a smartphone, a tablet, a slate, other hand-held device, or a webpage. In an example, the display can be via a portal or webpage of a social media website. In an example, the display can be a light-emitting diode (LED), such as but not limited to red/yellow/green readouts. The measurement of the device configuration and/or the analysis of the data from the device configuration can be stored to a local storage (including to memory of the system), an external storage, a database, a data center, and/or a cloud-based storage. In a non-limiting example, measurements could be stored during the course of the activity and analyzed once the activity is completed. In an example, the system can be connected via wired or wireless communication to the display to provide the indication of the force on the foot and/or footwear. In an example, the measurement of the device configuration and/or the analysis of the data from the device configuration can be communicated wired or wirelessly over a network. The communication can be a direct, wired connection through a connector means, or using a wireless means (including RF, inductive, and IR) to connect to a display. Other information based on the measurements and/or data analysis described herein can be stored and/or displayed to a display. Non-limiting examples of such other include the indication of suggested changes and/or improvements to gait and/or style, quantitative information about heel strike data or toe strike data, identification of trends of the force acting on the foot and/or footwear, and/or the indication of performance of a subject over time. In other examples, the other information that can be displayed can be statistical data including averages and medians. In any of the examples herein, the information can be displayed as a chart, as numbers, as graphs, and/or overlaid on maps or other visual indicators of regions of the foot.

In an example, a processor associated with the display can be configured to execute processor-executable instructions to analyze the data from any of the device configurations described herein. That is, an indication of the measured force can be provided based on an analysis of sensing device measurement(s) using a processor associated with the device configuration. Additional indication of the measured force may be provided from further analysis by a processor associated with the display (device). Such additional indication can be based on an analysis of the measurements from the sensing device(s) and/or the indication provided using the processor of the device configuration. The additional indication obtained using the processor of the display can include the indication obtained using the processor of the device configuration. The additional indication can be of the same quantitative value and/or visual form as the indication provided by the processor of the device configurations described herein, or can be of a different quantitative value and/or visual form.

In an example a device configuration described herein can include a power supply to provide power to one or more components, including to the microcontroller, the capacitive sensors, and/or the pressure sensitive rubber (where applicable). In another example, the device configuration can be configured for energy harvesting from the movement and/or pounding of the feet and/or footwear during the performance of an activity.

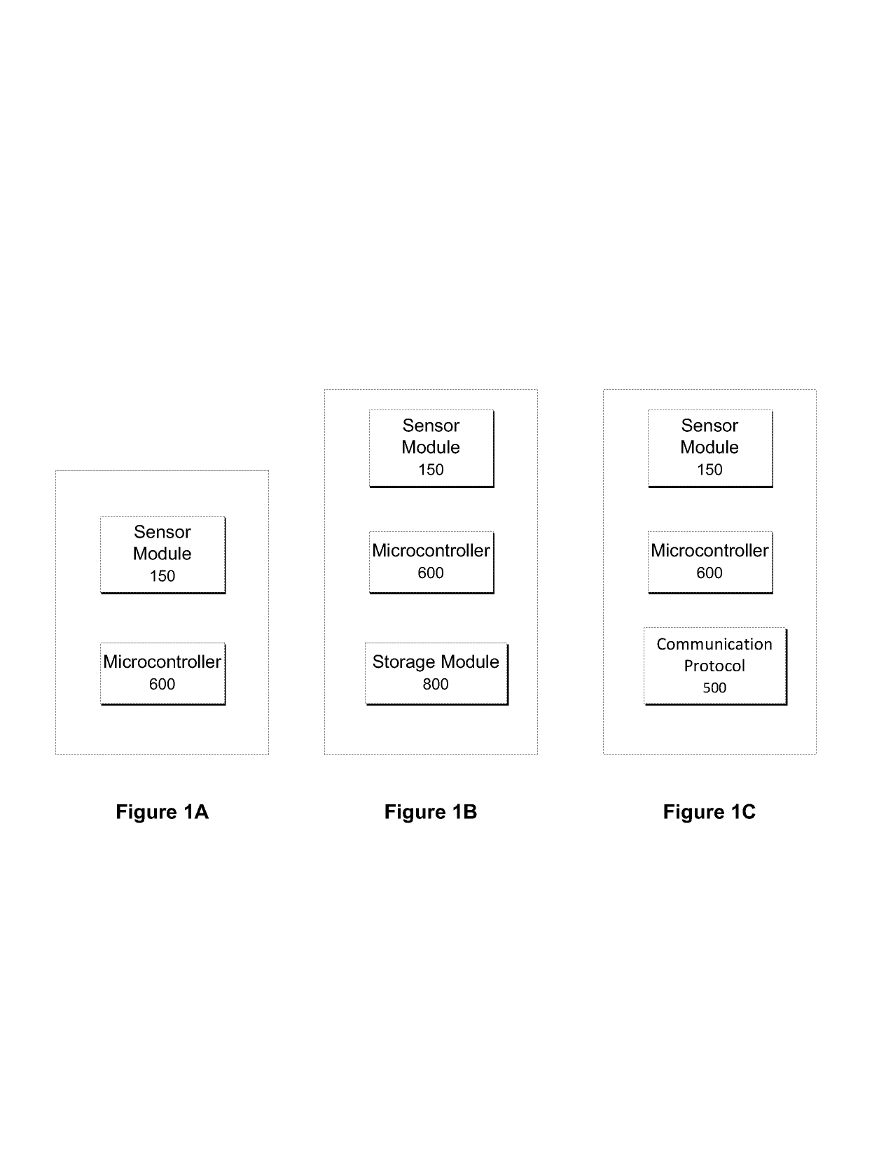

FIG. 1A shows a block diagram of an example system for providing an indication of the impact of a force acting on a foot or a footwear. The system includes at least one sensor module 150 that is configured to measure data indicative of a force or forces acting on the foot or footwear. The sensor module 150 includes at least one sensing device. The sensing device can includes one or more of any sensor component according to the principles of any of the examples and/or figures described herein. The example system of FIG. 1A includes a microcontroller 600 that includes at least one processor. The microcontroller 600 and the sensor module 150 can be part of an assembly that is disposed proximate to a region of the foot or the footwear. The at least one processor can be used to execute processor-executable instructions to analyze the data from the sensor module 150. The analysis provides an indication of a location of action of the measured force at a plurality of locations of the foot or the footwear. The example also can include a display to display the indication of the measured force. As non-limiting examples, the display can be a screen of a hand-held device, a liquid crystal display, a screen of a computing device, or a light emitting diode.

In an example implementation of the system of FIG. 1A, the sensor module 150 includes a sensing device that includes a single accelerometer. The sensing device is used to measure data relating to a force acting on the foot or the footwear. A processor of the microcontroller 600 is coupled to the sensing device. The processor is configured to execute processor-executable instructions to analyze the data from the sensing device to provide an indication of the measured force.

FIG. 1B shows another example system that includes sensor module 150, microcontroller 600, and a storage module 800. The storage module 800 can be configured to save data from at least one sensor component and/or the microcontroller 600. In some implementations the storage module 800 is any type of non-volatile memory. For example, the storage module can include flash memory, solid state drives, removable memory cards, or any combination thereof. In some implementations, the storage module is local to the device while in other implementations it is remote. For example, the storage module 800 can be a removable memory card housed the sole of a shoe or data could be sent to a smart phone and saved in the phone's internal memory. In some implementations, the sensor data can be stored on the storage module for further processing at a later time. The storage module 800 can include a memory to store the processor-executable instructions that are executed to analyze the data from the sensor module 150. In other examples, the memory of storage module 800 can be used to store the measured data relating to the force acting on the foot or the footwear, and/or the indication of the measured force.

FIG. 1C shows another example system that includes sensor module 150, microcontroller 600, and a communication protocol 500. For example, the communication protocol 500 can include a transmitter that is configured to transmit the data from the sensing device or the indication of the measured force to an external device. In another example, a processor of the external device can be configured to execute processor-executable instructions to analyze the data from the sensing device, and where the analysis provides the indication of the measured force acting on the foot or the footwear.

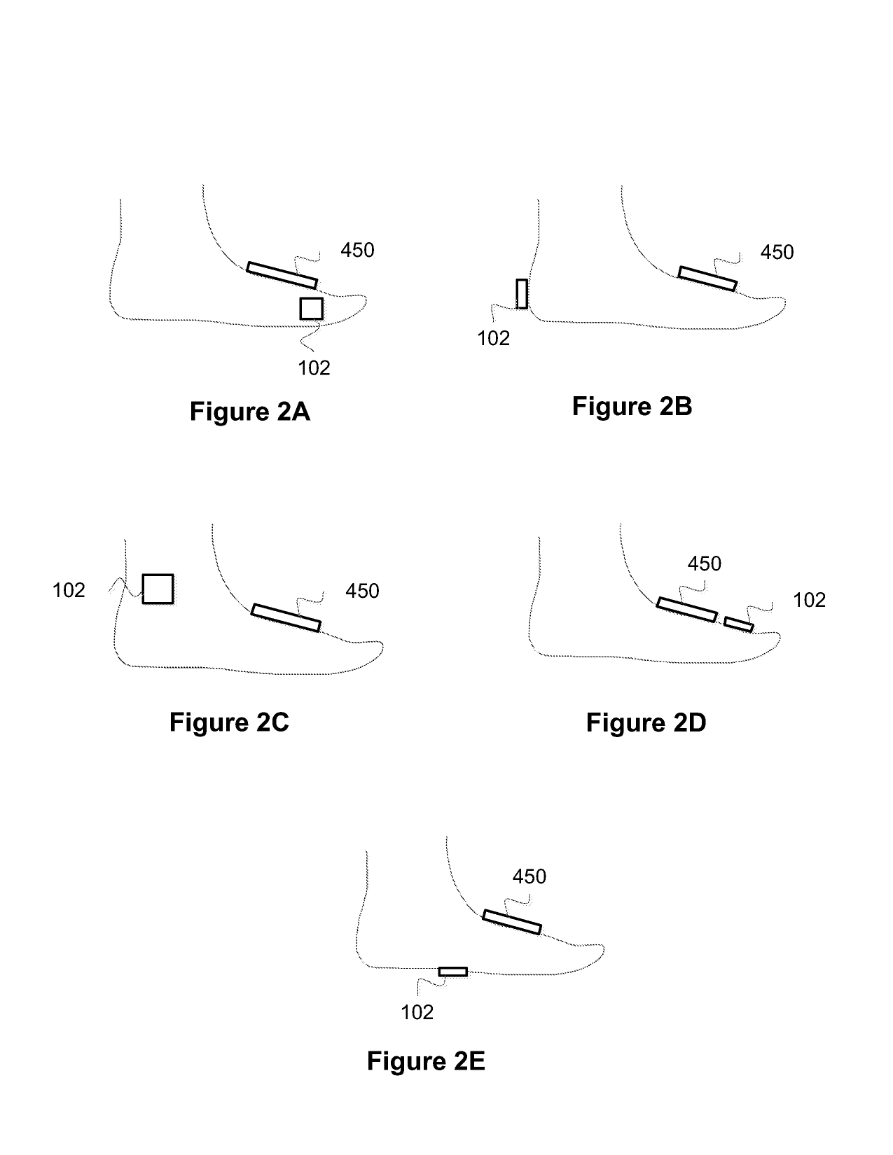

FIGS. 2A to 2E shows non-limiting examples of possible device configurations relative to a foot or footwear according to the principles herein. The example device configurations of FIGS. 2A to 2E include a sensor component 102 and a device housing 450. The device housing 450 can include at least one processor to execute instructions for analyzing data from the sensor component 102. The at least one processor can be part of a microcontroller 600. In different examples, the device housing 450 can include the storage module 800 and/or the communication protocol 500. The device housing 450 also may include one or more sensing devices. Any of the example systems can be configured to adhere to a foot, including as a sticker or a patch, or to be otherwise mounted to the foot using a fastener or as part of unit that is wrapped as a band about a portion of the foot. Also, while the examples of FIGS. 2A to 2E are illustrated as disposed at various positions relative to a foot, the example systems can be positioned in similar relative orientation and disposed in a shoe, including as part of a sock or other foot covering. The sensor component 102 can be conformed to any region of the foot. In the illustrations of FIG. 2A to 2E, the sensor component 102 is configured to conform to the region of the foot near the toe, heel, ankle, upper foot, and arch, respectively. In other examples, the sensor component 102 can be disposed at multiple regions of the foot, including at least two different of the foot (such as but not limited to near the toe, heel, ankle, upper foot, or the arch).

In an example, sensor component 102 can include at least one accelerometer, at least one gyroscope, or one or more of a contact sensor based on a pressure sensitive rubber, a capacitive sensor, a conformal contact sensor, or other type of pressure sensor. In addition, any of the sensor components described herein may be integrated into a single assembly, may be formed in a multi-piece assembly that is disposed at different locations about the foot or footwear, or may be formed in a multi-piece assembly with some members of the multi-piece assembly being co-located in close proximity at a region of the foot or footwear.

In some example implementations according to the principles herein, the components of the device configuration can be configured on a flexible substrate, including a flexible substrate that forms a part of, or is otherwise coupled to, a flexible housing. For example, the flexible substrate can include any one or more of a variety of polymers or polymeric composites, including polyimides, polyesters, a silicone or siloxane (e.g., polydimethylsiloxane (PDMS)), a photo-patternable silicone, a SU8 or other epoxy-based polymer, a polydioxanone (PDS), a polystyrene, a parylene, a parylene-N, an ultrahigh molecular weight polyethylene, a polyether ketone, a polyurethane, a polyactic acid, a polyglycolic acid, a polytetrafluoroethylene, a polyamic acid, a polymethyl acrylate, or any other flexible materials, including compressible aerogel-like materials, and amorphous semiconductor or dielectric materials. Reference to a device configuration that is configured on a flexible substrate includes device configurations that are disposed above the flexible substrate with one or more other intermediate materials, layers and/or components disposed between the device configuration and the flexible substrate.

In an example implementation, to facilitate the conforming of the device configuration (including the sensing device and/or device housing) to a region of the foot or footwear, some or all of the components of the sensing device or device housing disposed on or integrated with the flexible substrate or housing may be coupled to each other using one or more flexible and/or stretchable interconnects. Flexible and/or stretchable interconnects may employ metals (e.g., copper, silver, gold, aluminum, alloys) or semiconductors (e.g., silicon, indium tin oxide, gallium arsenide) that are configured so as to be capable of undergoing a variety of flexions and strains (e.g., stretching, bending, tension, compression, flexing, twisting, torqueing), in one or more directions, without adversely impacting electrical connection to, or electrical conduction from, one or more functional components of the sensing apparatus. Examples of such flexible and/or stretchable interconnects include, but are not limited to, serpentine interconnects, wavy interconnects, bent interconnects, or buckled interconnects.

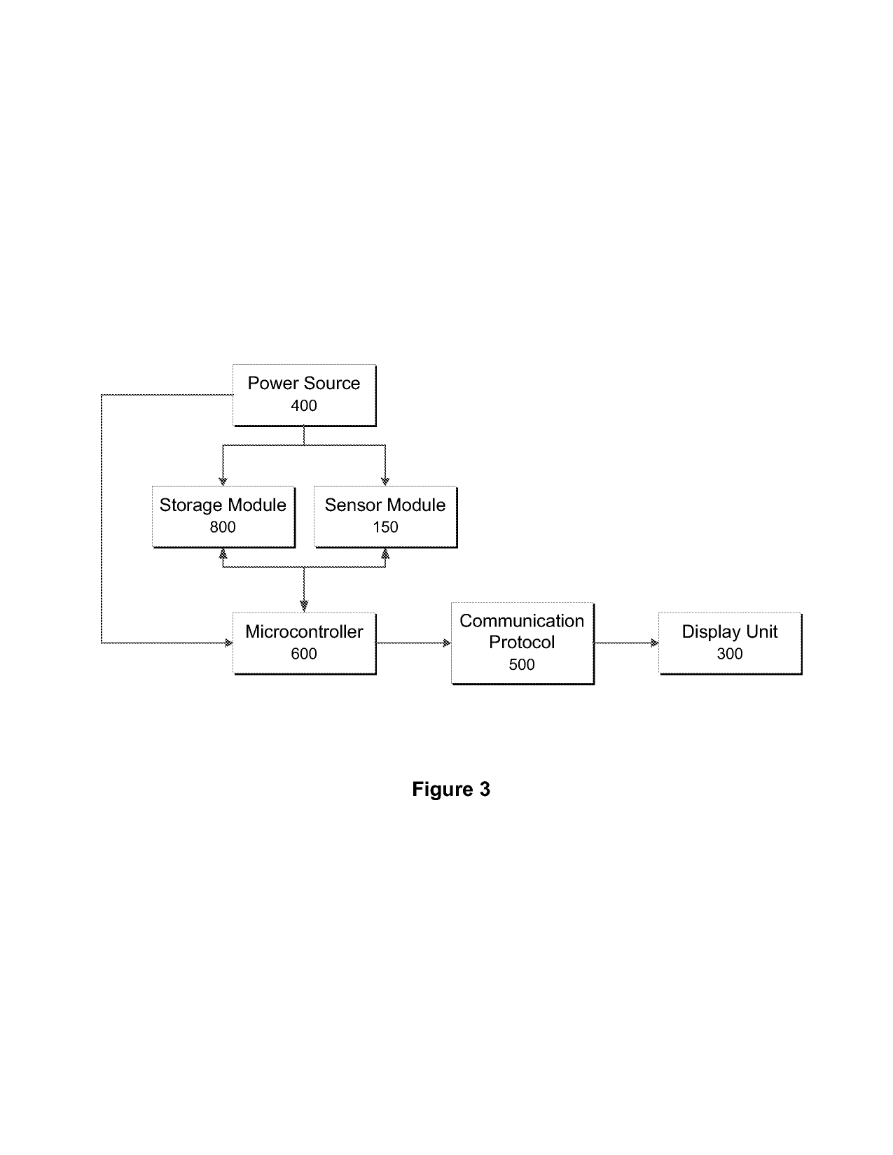

FIG. 3 shows a block diagram of another example system for providing an impact of a force acting on a foot or footwear. In a non-limiting example, the example system can be used for identifying the location and/or magnitude of a force acting on the foot or the footwear. The system includes at least one sensor module 150. In an example implementation, the sensor module 150 can be configured to send data to a device housing 450. The example system of FIG. 3 includes a microcontroller 600 that includes at least one processor. The at least one processor can be used to execute processor-executable instructions to analyze the data from the sensor module 150. The example system also includes a storage module 800. Data from the sensor module 150 can be saved to the storage module 800 for later review and/or processing. The sensor module 150 can be placed at a plurality of locations on the foot. The system also includes at least one power source 400. The system also includes a display unit 300 for displaying information to a user. This display unit 300 is used to display the raw and/or processed data. In some implementations the display provides a visual indication of gait, pronation, rotation, forces, performance stat, trends or any combination thereof. In some implementations, the device components are connected via wires or wireless systems, such as Bluetooth, RF, or inductive. In some implementations the system is integrated into a shoe, sock or sticker that is applied to the foot.

The example system of FIG. 3 can be implemented on a foot or in footwear according to any of the example device configurations described herein, including in the device configurations described above in connection with FIGS. 2A to 2E. For example, example system of FIG. 3 may be disposed in various regions of footwear (e.g., in the sole of footwear), or may be disposed in a sock or other insert into footwear. In an example, the sensor component 102 or device housing 450 can include at least one accelerometer, at least one gyroscope, or one or more of a contact sensor based on a pressure sensitive rubber, a capacitive sensor, a conformal contact sensor, or other type of pressure sensor. In an example, the sensor component 102 or device housing 450 can include at least one of the microcontroller 600, the power source 400, the display unit 300, and the storage module 800, or one or more sensors, or any combination thereof. The device housing 450 can include at least one processor to execute instructions for analyzing data from the sensor component 102. The at least one processor can be part of a microcontroller 600.

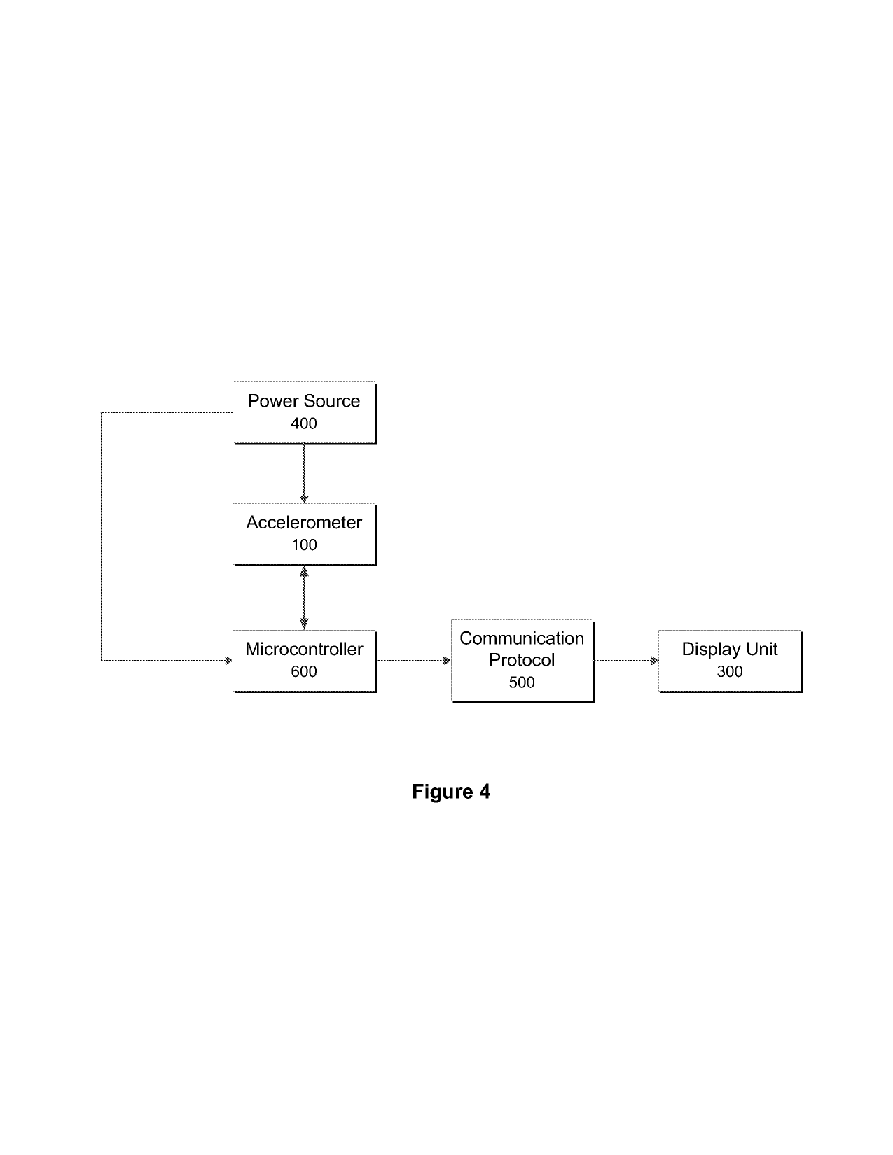

In an example system according to the principles of FIG. 1A, the sensor module 150 can include at least one accelerometer. Such an accelerometer is also illustrated in FIG. 4. As described above, sensor module 150 can be part of a sensing device. In various examples, the at least one accelerometer 100 can be placed at different locations around the foot or footwear, including any of the example device configurations described herein, such as those described above in connection with FIGS. 2A to 2E. As described above, the at least one accelerometer 100 can be used to detect a change in motion and/or orientation of a portion of the foot or footwear. In other examples, the at least one accelerometer 100 is a component of a sensing device that is configured to detect changes in acceleration, changes in orientation, vibrations, and/or falling motion, which can be correlated with the action of a force to a portion of the foot or footwear. For example, a system including at least one accelerometer 100 could be coupled to the foot or footwear and be configured for use to detect when a foot is brought in contact with an object, and the orientation of the foot at the time of impact with the object.

In an example system according to the principles of FIG. 1A and FIG. 4, microcontroller 600 can include at least one processor that is configured to execute processor-executable instructions to analyze the data from the sensing device. For example, the processor-executable instructions can include instructions to analyze the data to provide an indication of the location of the action of the measured force at a plurality of locations of the foot or the footwear.

In an example, microcontroller 600 can include a location computation module that includes the processor-executable instructions to analyze the data to provide an indication of the location of the action of the measured force at a plurality of locations of the foot or the footwear. The surface on which the impact occurred can be determined by placing an accelerometer 100 in a known location on the foot or footwear and measuring the vector components of the acceleration along a pre-defined x, y, and z axis. For example, if an accelerometer 100 is placed on the top surface of the foot, and the accelerometer detects an upward movement along the z axis, then the location computation module can be used to compute the location of the impact on the foot or footwear (here, the impact could be localized to a portion of the base of the foot or footwear). In some examples, based on the input from the at least on accelerometer 100, the microcontroller 600 can be configured to consult a calibration standard (including a table or a file) to determine where an impact occurred on the foot or footwear.

In an example system according to the principles of FIG. 1A and FIG. 4, the accelerometer 100 can be a triple-axis accelerometer. The processor-executable instructions of the location computation module can include instructions to compute a projection of the measured vector components of the triple-axis accelerometer at the plurality of locations relative to the foot or footwear (including as a vector sum analysis of the output of the accelerometer).

In another example system according to the principles of any of FIGS. 1A-C or FIG. 4, the at least one accelerometer 100 can be a low-G accelerometer. Microcontroller 600 can include a data computation module that includes processor-executable instructions to compute data relating to the force acting on the foot or the footwear that is not measured using the low-G accelerometer.

In some example implementations, the data computation module can include processor-executable instructions that cause a processor to perform a linear interpolation to generate data for the data points that are not measured using the low-G accelerometer. In other example implementations, the processor-executable instructions can cause a processor to perform a curve fit based on a pre-determined waveform to generate the non-measured data. For example, the waveform can be determined based on a priori knowledge of candidate waveforms or a curve fit based on a set of known standards of the performance of low-g accelerometers for different applied forces. For example, low-g accelerometer may have a dynamic range capable of detecting up to only about 10 g forces. A foot or footwear may be subjected to higher forces outside this dynamic range during the course of an activity. In some example implementations, prior knowledge of candidate waveform shapes can be used to recreate a standard waveform for analysis of the sensor data. The standard waveform covers ranges that would be outside the dynamic range of the low-g accelerometer.

In a non-limiting example, the at least one accelerometer 100 can be a low-G, triple-axis accelerometer. The data computation module can include processor-executable instructions that cause a processor to perform a linear interpolation or a curve fitting (as described herein) to compute data relating to the force acting on the foot or the footwear that is not measured using the low-G, triple-axis accelerometer.

As shown in the example system of FIG. 4, device housing 500 or sensor component 102 can also include a power source 400 and a communication protocol 500. The display unit 300 can be integrated with the device housing 500 or sensor component 102, or can be an external display.

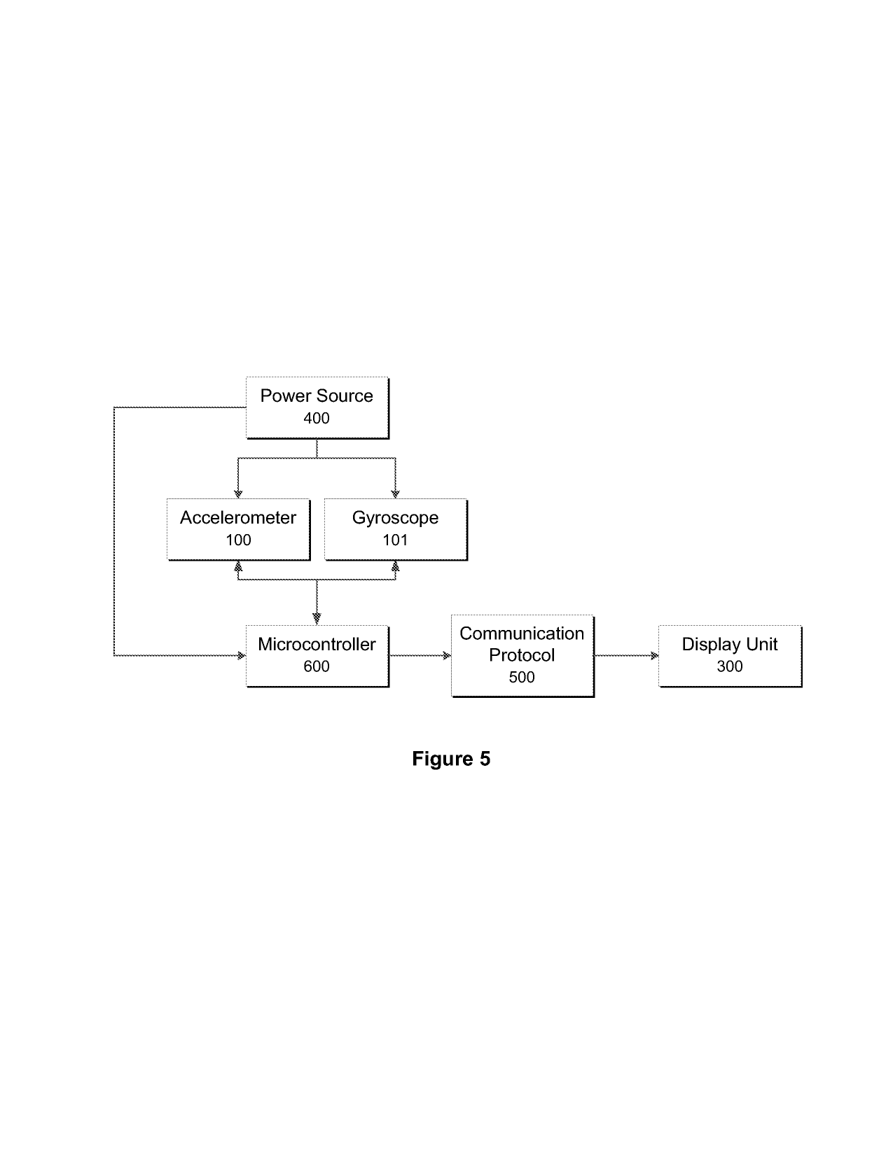

In another example system according to the principles of any of FIGS. 1A-C, the sensor module 150 can also include at least one accelerometer and at least one gyroscope. FIG. 5 shows another example system that also includes at least one accelerometer 100 and at least one gyroscope 101. The at least one gyroscope 101 can be used to measure data relating to the location of action of the force and/or a magnitude of the force acting on the foot or footwear. Microcontroller 600 can include both a location computation module and a magnitude computation module. The magnitude computation module includes processor-executable instructions to compute the magnitude of the force acting on the foot or footwear based on at least the measured data from the gyroscope 101.

In an example, the at least one gyroscope 101 can be disposed at two or more locations about the foot. The gyroscope can be used to measure an orientation of a portion of a foot or footwear. In some implementations, the orientation data is combined with the accelerometer data to determine the location and/or magnitude of the forces acting on the foot or footwear.

In some example implementations, the magnitude computation module includes instructions to consult a predefined standard table or file for correlating sensor data, such as the from the accelerometer and/or the gyroscope, to the magnitude of the impact. For example, the standard table or file can be generated based on an analysis of training data based on a plurality of known forces applied to a plurality of known locations around a modeled foot or footwear. In an example for obtaining the training data, a plurality of accelerometers and a plurality of gyroscopes can be coupled to the modeled foot. Data from a measurement by the accelerometer and/or gyroscope can be analyzed by comparing the measured values to the predefined standard, and based on data about the location(s) of the accelerometer and/or the gyroscope on the foot or footwear. In some example implementations, the magnitude computation module can also include instructions to evaluate the weight of the subject performing the activity in analyzing the measurements from the accelerometer and/or the gyroscope to provide the indication of the measured force. In an example, the magnitude computation module can also include instructions to using measured data from a foot or footwear to further refine the predefined standard table or file.

In an example, the gyroscope can be used to measure an angular rotation of the foot or footwear based on the action of the force. In this example, the magnitude computation module includes the processor-executable instructions to analyze the data to provide an indication of where the force is acting on the foot. In some example implementations, the gyroscope is used to further refine the location determination. For example, the gyroscope can be sued to monitor angular rotation of the foot or footwear. With this information, the location computation module can determine how the foot or footwear is rotating, for example about the ankle joint or about the toes. As a non-limiting example, the data analysis can indicate that the force is acting at a heel region or a toe region of the foot or footwear.

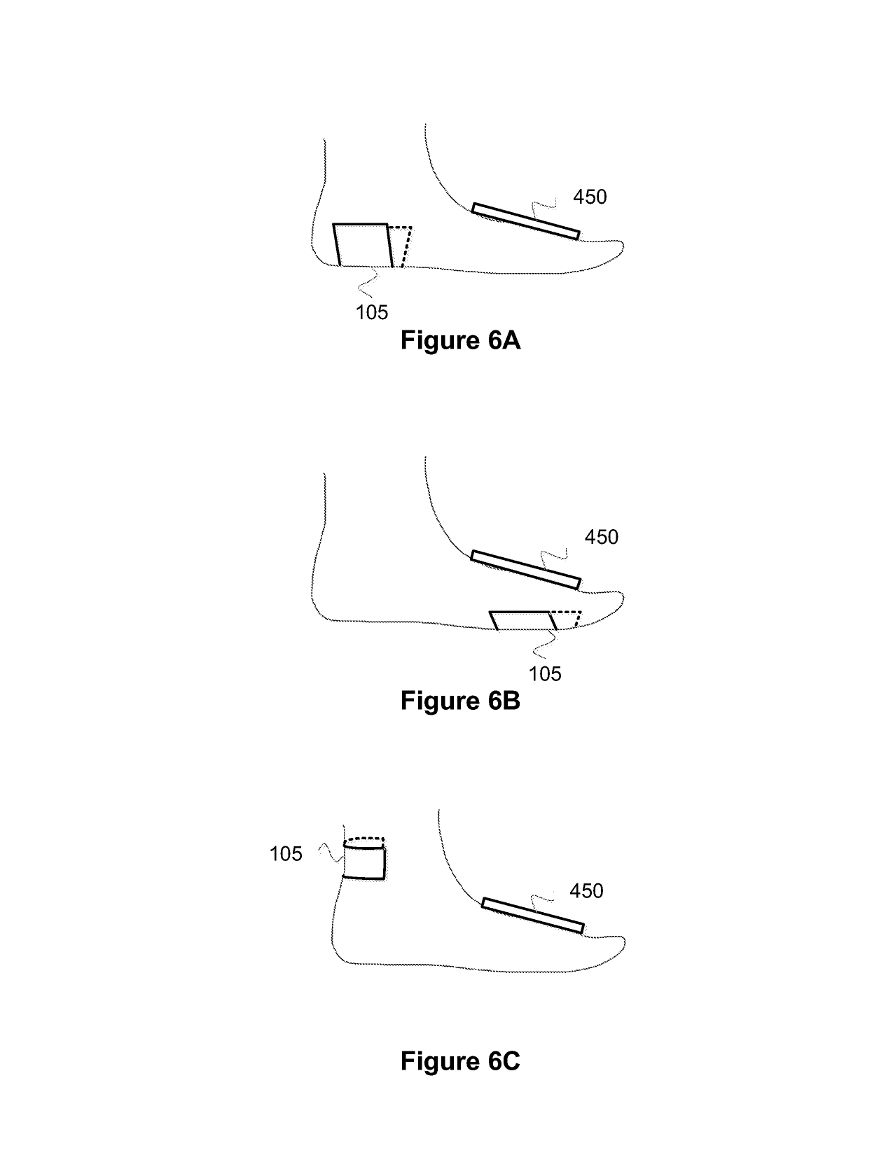

FIGS. 6A-6C illustrate example device configurations according to the principles herein that include a device housing 450 and at least one sensor component 105 that conforms to a portion of the foot or footwear. The device configuration as illustrated in FIGS. 6A-6C can be configured to adhere to a foot, including as a sticker or a patch, or to be otherwise mounted to the foot using a fastener or as part of unit that is wrapped as a band. Also, while the example of FIGS. 6A-6C is illustrated as disposed at various positions relative to a foot, the device configuration can be positions in similar relative orientation and mounted in a shoe, as part of a sock or other foot covering. In the illustration of FIG. 6A the sensor component 105 is configured to conform to the region of the heel of the foot. In other examples, the sensor component 105 is configured to conform to the region of the instep of the foot (shown in FIG. 6B) or the region of the ankles (shown in FIG. 6C). In another example, the sensor component 105 can be configured to conform the region of the toe of the foot or to a region of the top of the foot. In yet other examples, the system can include more than one sensor component 105 disposed at multiple locations relative to the foot or footwear.

In various example implementations, the sensor component 105 can include at least one of an accelerometer, or at least one gyroscope, or one or more of a contact sensor based on a pressure sensitive rubber, a capacitive sensor, a conformal contact sensor, or other type of pressure sensor. The example systems of any of one of FIG. 1A-1C, 3-5, 7 or 9 can be implemented in a conformal configuration, including in any of the configurations described herein in connection with FIGS. 6A-6C.

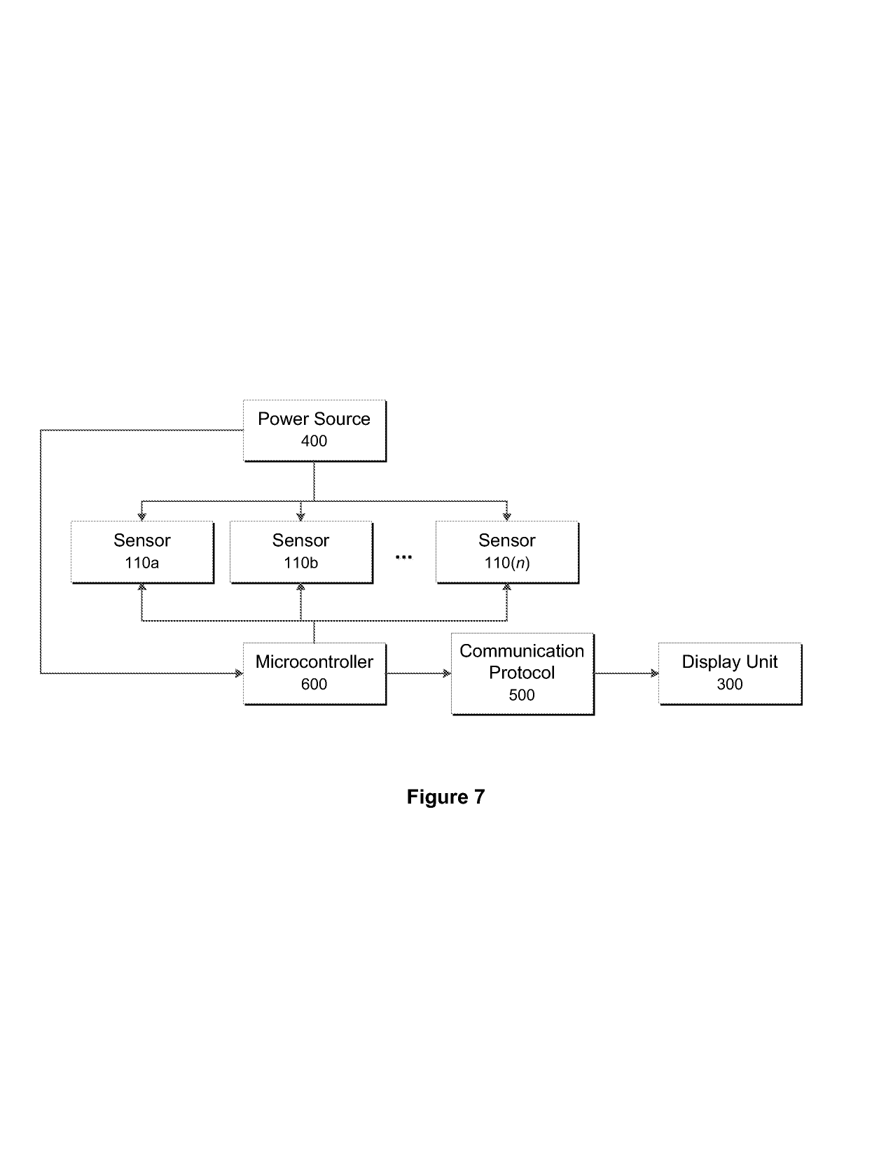

In an example implementation, the sensor component 105 can include an array of conformal contact sensors 110i (i=a, . . . n). The array of conformal contact sensors 110i can include at least one conformal contact sensor, at least two conformal contact sensors, or more, up to any number of conformal contact sensors. Example systems according to the principles of this example implementation can be configured as any of FIGS. 1A-C or FIG. 7. The array of contact sensors 110i can be disposed in any location relative to a foot or footwear. As non-limiting examples, contact sensors 110i can be disposed in a shoe, a sock, or configured as a sticker. FIG. 7 shows a block diagram of an example system for providing an indication of an impact of a force acting on a foot or footwear. In a non-limiting example, the example system can be used for identifying the location and/or magnitude of a force acting on the foot or the footwear. The microcontroller 600 of any of FIGS. 1A-C or FIG. 7 can be coupled to at least one of the contact sensors 110i of the array. At least one processor of microcontroller 600 can be configured to execute processor-executable instructions to analyze the data from the contact sensors 110i, where the analysis provides an indication of the measured force.

In an example, microcontroller 600 can include a magnitude computation module that is configured to execute processor-executable instructions to compute data relating to a magnitude of the force acting on the foot or the footwear. As a non-limiting example, the conformal contact sensors may provide only an indication that one or more members of the array measured a force acting but do not quantify the magnitude of the force. The magnitude computation module can be applied to quantify a magnitude of any such force.

In an example device configuration based on the example system of any of FIGS. 1A-C or FIG. 7, the contact sensors 110i can be configured to sends data to a device housing 450 using a communication protocol 500. The device housing 450 can also include a power source 400, a display unit 300. In an example, the device housing 450 also can include at least one accelerometer and/or at least one gyroscopes.

The device housing 450 in FIGS. 2A-2E and 6A-6C is illustrated as being disposed on or near the top of the foot or footwear. In other examples, device housing 450 be disposed in the sole of a shoe, a various regions of the foot, disposed in a sock or other foot covering, or located remotely.

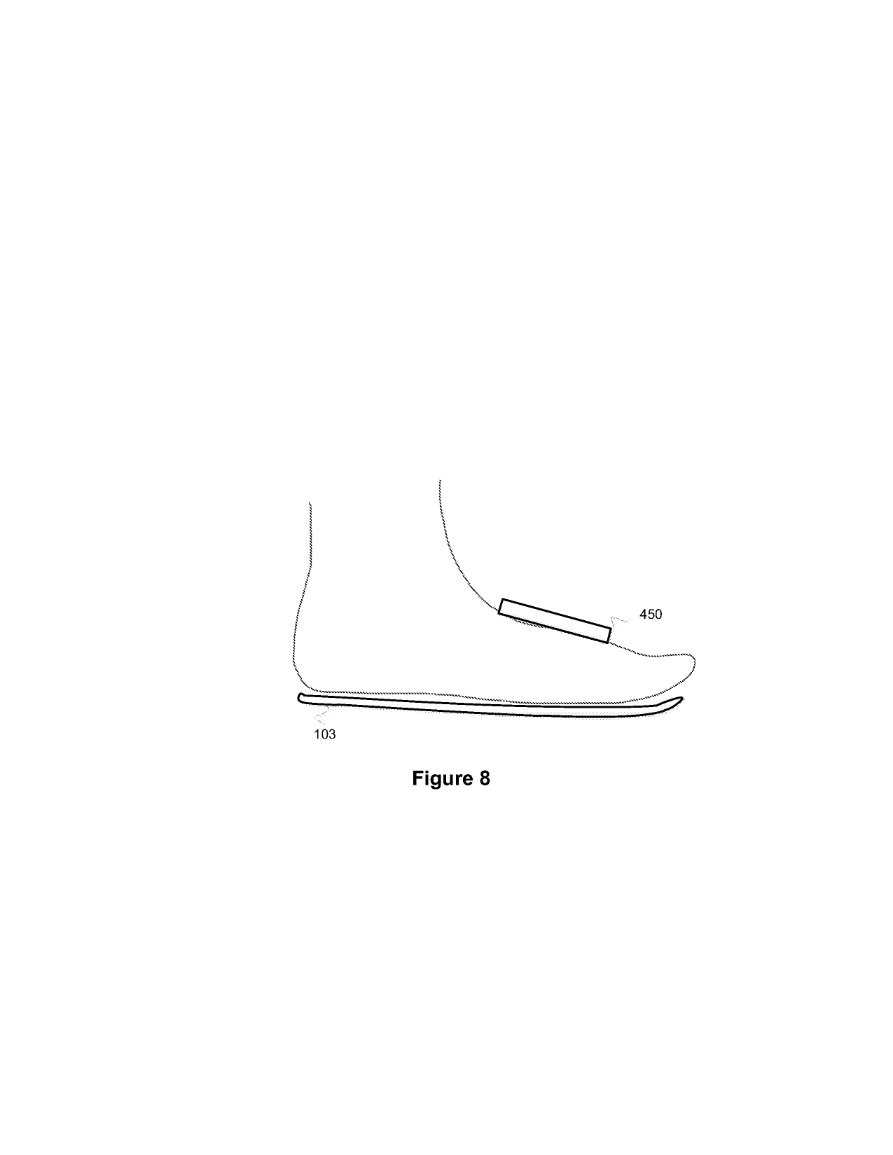

FIG. 8 illustrates an example device configuration according to the principles herein that include a device housing 450 and at least one pressure sensitive sensor component 103. In an example, the pressure sensitive sensor component 103 can be configured to conform to a portion of the foot or footwear. The pressure sensitive rubber acts as a variable resistor. That is the application of pressure to the pressure sensitive rubber induces a change in resistance in the pressure sensitive rubber sensor 103. When a voltage is applied to the pressure sensitive rubber, the current (which varies depending on the pressure exerted), can be measured to quantify the pressure. The pressure sensitive rubber is configured to detect pressure over a given area. The measure of pressure on the pressure sensitive rubber sensor component 103 can be used to determine how much force is applied to regions of the foot.

The device configuration as illustrated in FIG. 8 can be configured as an insert to a shoe, can be configured to adhere to a portion of a foot, including as a sticker or a patch, or to be otherwise mounted to the foot using a fastener or as part of unit that is wrapped as a band. In another example, the pressure sensitive sensor component 103 can be mounted in a portion of a shoe, such as but not limited to the sole of the shoe, as part of a sock or other foot covering. In the example of FIG. 8 the pressure sensitive sensor component 103 is configured to conform to substantially the length of the foot (or footwear). In other examples, the pressure sensitive sensor component 103 can be configured to conform to a region of the heel of the foot, a region of the instep of the foot, a region of the toe, a portion of the top of the foot, or other region of the foot, whether in direct contact with the foot, as pert of footwear, or as an insert to the footwear. In one example implementation, the pressure sensitive rubber component 103 can be molded to form the sole of a footwear or an insole. In other examples, the insole can be inserted into a pair of shoes or may be incorporated into a sock-like article of clothing. In yet other examples, the system can include more than one pressure sensitive sensor component 103 disposed at multiple locations relative to the foot or footwear.

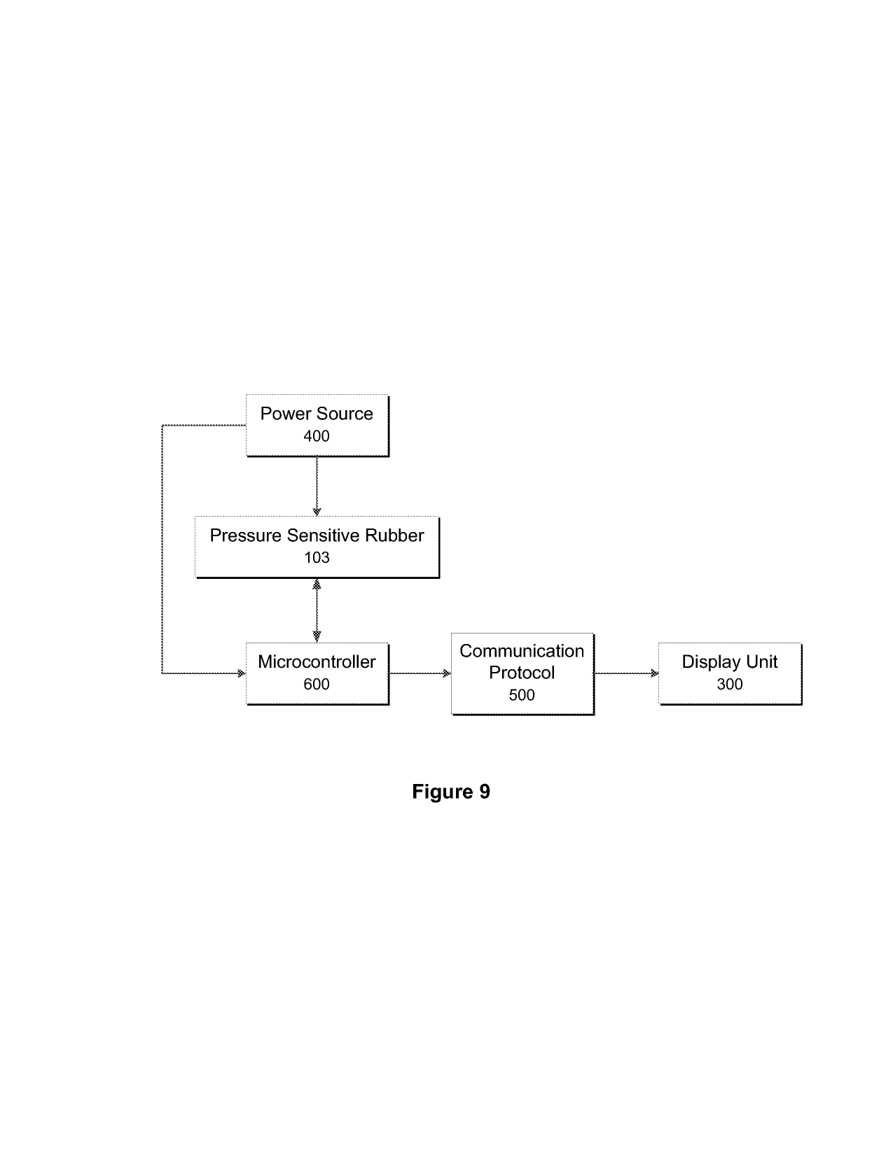

FIG. 9 shows a block diagram of another example system according to the principles herein that includes sensing devices based on a pressure sensitive rubber. This example system also can be configured as of any of FIGS. 1A-C. This example implementation can be used to identify the location and/or magnitude of force acting on the foot or footwear. In some example implementation, the sensor module includes a microcontroller 600 that is coupled to the pressure sensitive rubber sensor component 103. The microcontroller 600 can be used to monitor a voltage drop across the pressure sensitive rubber sensor component 103. A processor of the microcontroller 600 can be used execute processor-executable instructions to calculate pressures applied to pressure sensitive rubber sensor component 103. The computed pressures can be used to provide an indication of the forces acting on the foot or footwear.

In an example, the microcontroller 600 can include at least one of a location computation module and a magnitude computation module to analyze the computed pressures to provide the indication of the forces acting on the foot or footwear.

FIG. 9 shows the example system can further include at least one of a power source 400. The at least one power source can be used to apply the voltage to the pressure sensitive rubber sensor component 103 to facilitate detecting the force acting on the foot or the footwear.

In an example implementation of the device configuration of FIG. 8, the pressure sensitive rubber 103 can be communicatively coupled to the device housing 450 by communication protocol 500. In different examples, the device housing 450 can includes a microcontroller 600, power source 400, display unit 300, other sensors, or any combination thereof.

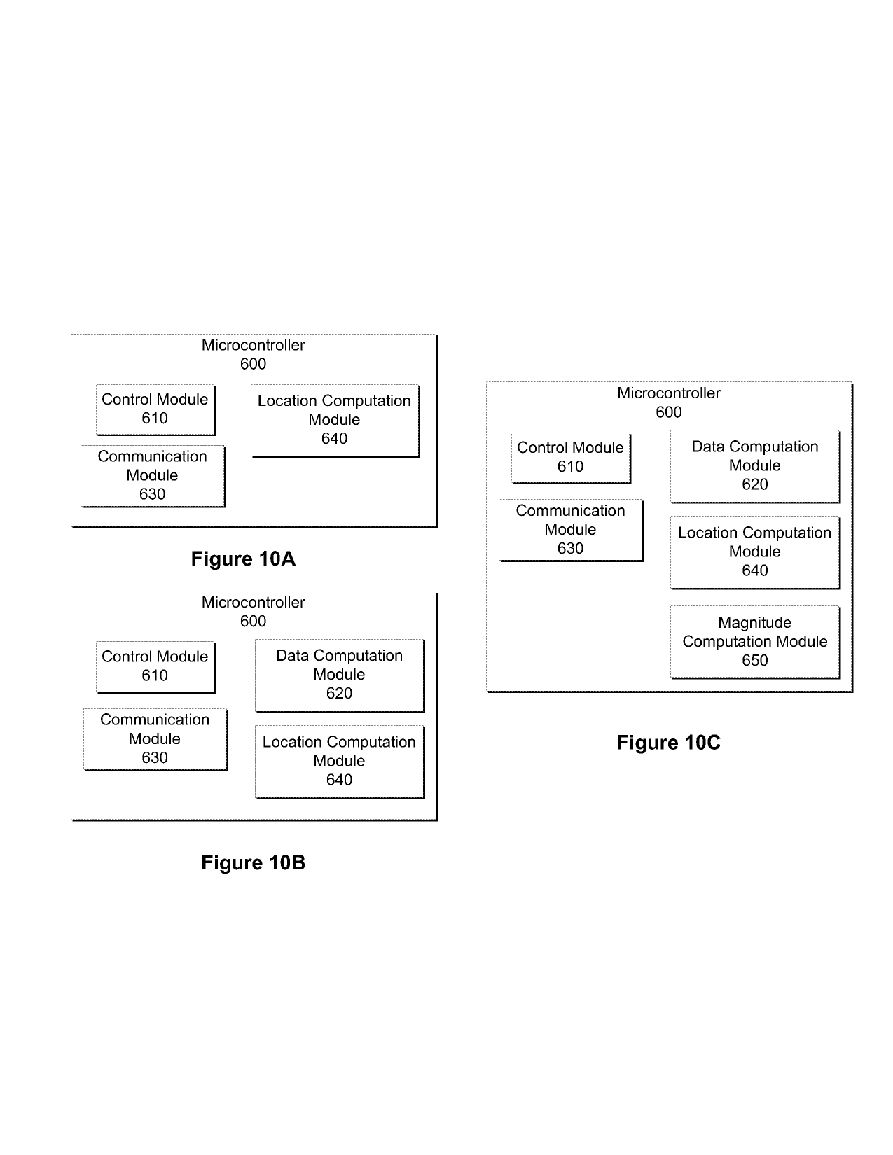

FIGS. 10A-10C show block diagrams of different configurations of example microcontrollers 600 of example systems herein for generating an indication of a measured force. In the example of FIG. 10A, the microcontroller 600 includes a control module 610, a communication module 630, and a location computation module 640. In the example of FIG. 10B, the microcontroller 600 includes a control module 610, data computation module 620, a communication module 630, and a location computation module 640. In the example of FIG. 10B, the microcontroller 600 includes a control module 610, data computation module 620, a communication module 630, a location computation module 640, and a magnitude computation module 650.

In some example implementations, the microcontroller 600 is deposited on a flexible substrate and communicatively coupled to the at least one sensing device. A processor of the microcontrollers 600 can be configured to receive and process at least one output signal from the at least one sensing device. The microcontroller 600 can be configured to output data to a user and/or execute instructions to store the data to a memory. The microcontroller 600 can be configured to include a control module 610. The microcontroller 600 also can be configured to include a communication module 630. The communication module 630 can be configured to process communications between the sensing device(s) or device housing(s) and the display unit(s) and/or other devices. The communication module 630 can be configured to communicate with a display unit through a plurality of communication protocols. For example, the communication module can communicate with a display via a wireless protocol, serial protocol, parallel protocol, or any combination thereof. In some example implementations, the communication module 630 can be configured to communicate with other devices. For example the communication module 630 may communicate with a smart phone, laptop computer, desktop computer, or tablet computer. In some example implementations, such as FIG. 10A, microcontroller 600 includes a location computation module 640. The location computation module 640 can be configured to receive data from at least one sensing device and compute a measure of the force(s) acting on a foot or footwear. The example implementation illustrated in FIG. 10B includes a data computation module 620. In some example implementations, sensing devices with low sampling rates can be employed in the system to minimize cost and power consumption. The data computation module 620 can be configured to receive data from sensing devices and interpolate data points between of the low sampled data. The example implementation illustrated in FIG. 10C includes a magnitude computation module 650. The magnitude computation module 650 can be configured to receive data from at least one of the sensing devices and determine the magnitude of a force acting of the foot or footwear.

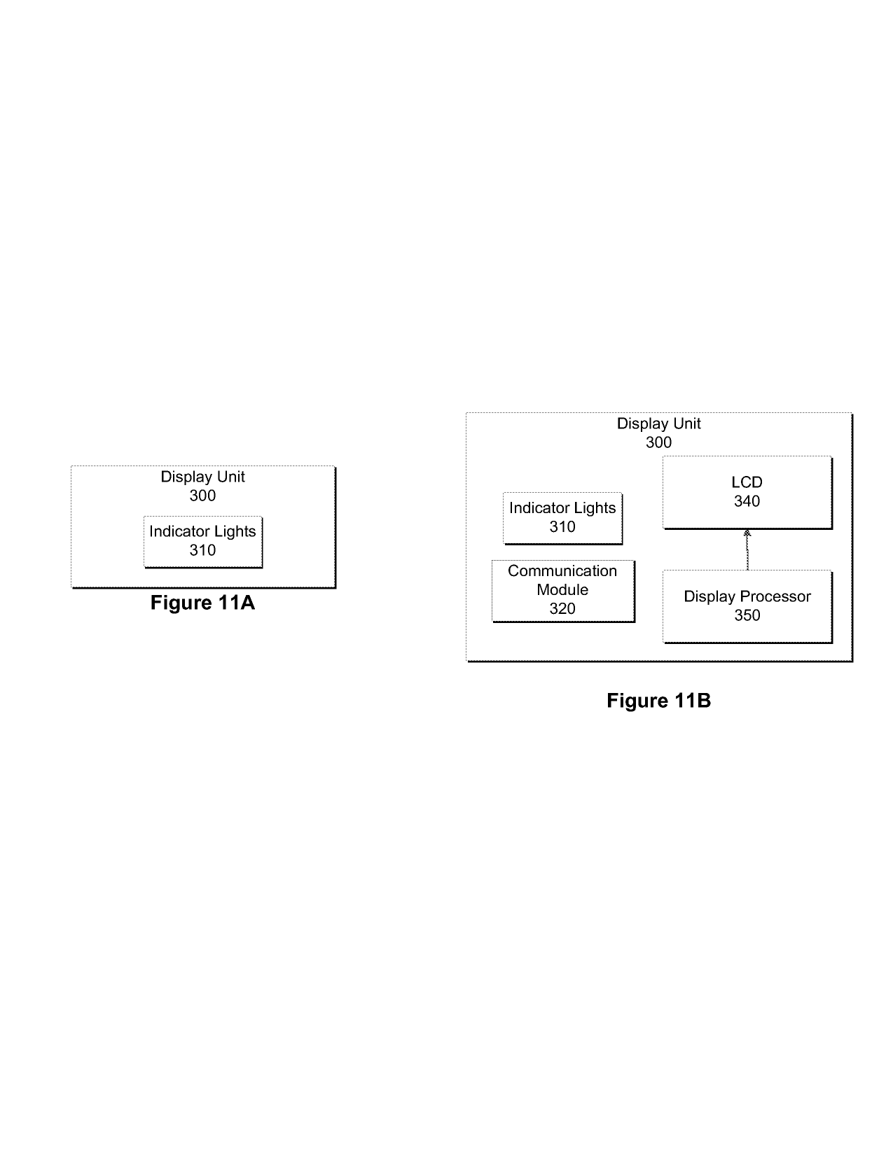

FIGS. 11A-11B show block diagrams of example display units 300. The example display units 300 include at least one module configured to display data to a user. In the example implementation of FIG. 11A, the display unit 300 includes a plurality of indicator lights 310. For example, the display unit 300 can include a series of light emitting devices that range from green to red. If an impact is over a certain predetermined threshold is detected, the red indicator light can be activated. If an impact under the pre-determined threshold, the green indicator light can be activated. In the example implementation of FIG. 11B, the display unit 300 can be configured to include indicator lights 310, communication module 320, and a liquid crystal display (LCD) 340 or other type of graphical display. The display unit 300 also can be configured to include a display processor 350. The display processor 350 can execute processor executable instructions to control the graphics or other information sent to the LCD 340 (for example, using communication module 320).

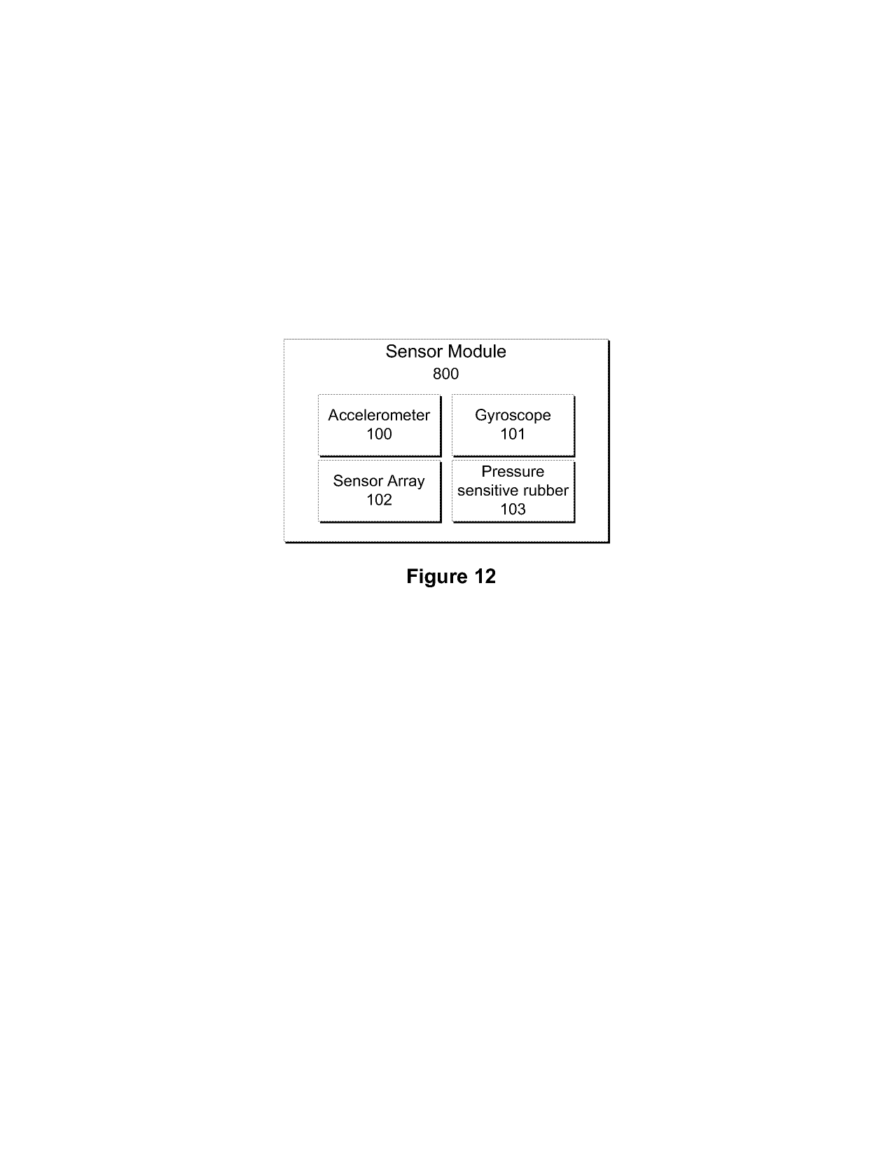

FIG. 12 shows a block diagram of an example sensor module 800. In different examples, the sensor module can include one or more of an accelerometer 100, a gyroscope 101, a sensor array 102, and a pressure sensitive rubber 103 (according to the principles described herein). The sensor array 102 can include at least one sensing device, at least two sensing devices, or more, up to any number of sensing devices. In some example implementations, the sensor module 800 can be removable and configurable for the activity to be monitored. For example, a footwear may include a removable sensor module 800. In different examples, when a user is engaged in an activity (such as but not limited to marching in the military, playing soccer, walking in orthopedic footwear, etc.), the user may choose to place a sensor module 800 that includes an accelerometer and a gyroscope into the footwear to measure the forces acting due to the motion during the activity. In an example where a user is walking, the user may replace a first type of sensor module 800 with a second type of sensor module 800 that includes at least one different type of sensing device (such as but not limited to a pressure sensitive rubber sensor component) to determine the amount of force applied to the heel during walking.

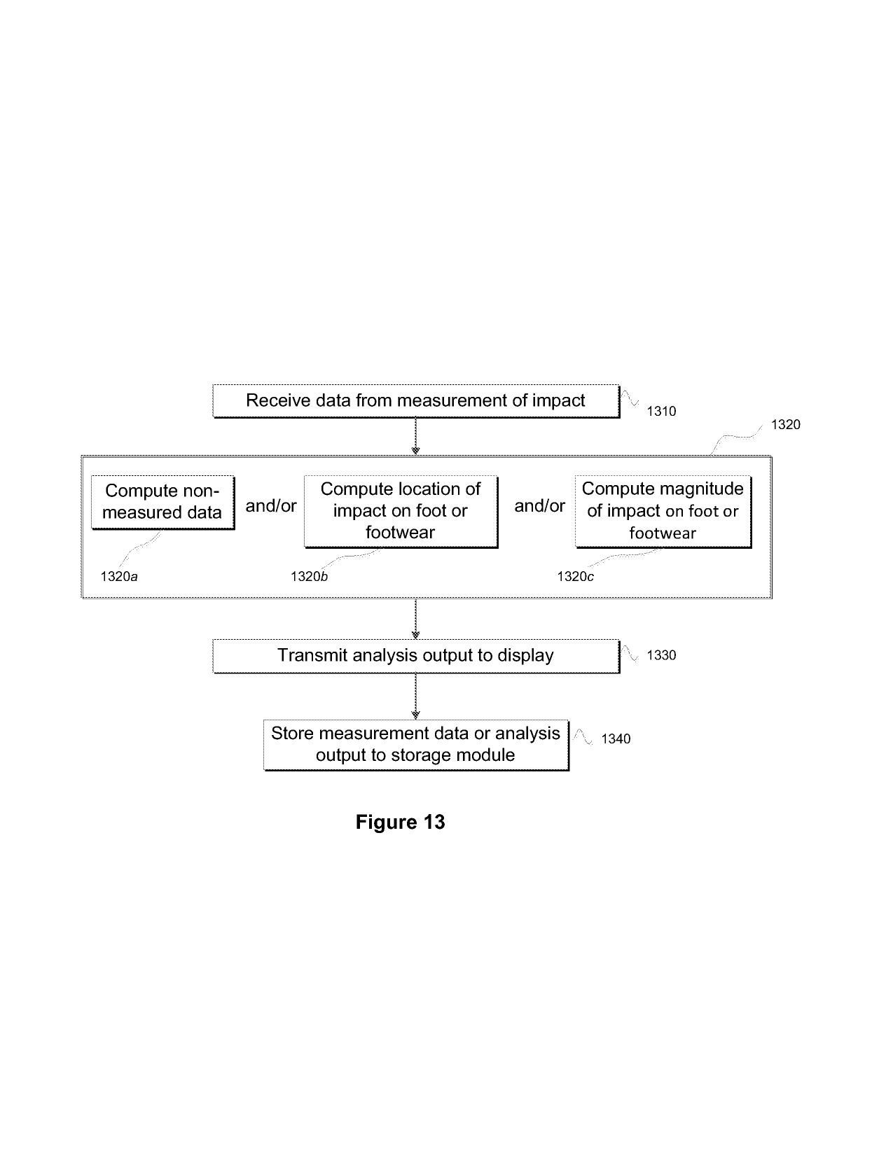

FIG. 13 shows a flow chart illustrating a non-limiting example method of providing an indication of a force acting on a foot or footwear, according to the principles described herein.

In block 1310, a microcontroller 600 receives data from at least one measurement of an impact.

In block 1320, the microcontroller 600 analyzes the data according to the principles described herein. For example, in block 1320a, the microcontroller 600 can be used to compute non-measured data (as described in one or more of the examples hereinabove). In another example, in block 1320b, the microcontroller 600 can be used to compute the location of the impact on the foot or the footwear (as described in one or more of the examples hereinabove). In another example, in block 1320c, the microcontroller 600 can be used to compute the magnitude of the impact on the foot or the footwear (as described in one or more of the examples hereinabove). As indicated in FIG. 13, each of blocks 1320a, 1320b, and 1320c can be performed alone or two or more the blocks 1320a, 1320b, and 1320c can be performed in any combination. In any given implementation, the computation of any one or more of blocks 1320a, 1320b, and/or 1320c can be performed according to the principles herein (including as described in connection with one or more of the examples hereinabove).

In block 1330, the microcontroller 600 transmits the output of the analysis of the measurement data to a display. In block 1340, the microcontroller 600 stores the measurement data and/or the analysis output to a storage module.

As described above, the microcontroller 600 can be used to receive data from at least one measurement of an impact (block 1310). In some example implementations, the example system can be configured to include at least one sensor module. The sensor component(s) of the example system can be used to detect a plurality of impacts based on the movement data such as acceleration, velocity, orientation, or any combination thereof. When a force is applied to a foot, the at least one sensor module can be used to detect the force as a change in acceleration, a change in velocity, a change in orientation, or any combination thereof. The sensor module can be configured to transmit the measurement data to a microcontroller 600 for analysis.

In block 1320, the microcontroller 600 is used to analyze the data according to the principles described herein.

For example, the data computation module can be used to compute the non-measured data (block 1320a) according to the principles described hereinabove. In some example implementations, the sampling rate of a sensing device may not be adequate to accurately calculate location and/or magnitude parameters. In an example implementation, the non-measured data computation module 620 can be used to interpolate data points between actual sampled points.

In another example, the location computation module can be used to compute the location of the force acting on the foot or footwear (block 1320b) according to the principles described hereinabove. In some example implementations, the location computation module 640 can use at least one data set from a sensing device herein to determine the location of a force acting on the foot or footwear.

In another example, the magnitude computation module can be used to compute the magnitude of the impact acting on the foot or footwear (block 1320c) according to the principles described hereinabove. In some example implementations, the magnitude of the impact can be calculated using the magnitude computation module 650 using at least one data set from a sensing device. In some example implementations, the magnitude computation module 650 can incorporate data from at least one sensing device, data computed using the data computation module 620, and/or the location information determined using the location computation module 640, to compute the magnitude information.

In block 1330, the microcontroller 600 is used to output information to a display. In some example implementations, the microcontroller 600 can use a communication module 630 to communicate with at least one display unit in order to display data to a user. In some example implementations, the microcontroller 600 transmits the output to the display using a wireless protocol and/or a wired protocol. In some example implementations, the display unit is local to the device configuration. In other example implementations, the display unit is remote to the device configuration. In an example, the microcontroller can be used to wirelessly transmit using a Bluetooth transmission protocol, the analysis output data to a user's watch, smartphone, slate or tablet for display to the user.

In block 1340, the microcontroller can be used to store the measurement data and/or the analysis output to a storage module. The storage module can include a plurality of memory types, such as volatile and/or non-volatile memory. In some example implementations, the microcontroller can be used to store the measurement data and/or the analysis output to the storage module for later display or analysis, including for on-line or off-line processing. For example, stored measurement data and/or analysis output can be later analyzed to provide gait analysis, or for tracking statistics (such as but not limited to length or heel strike or toe strike during a walk or a run). The storage module can be located local to the device configuration, such as onboard memory or flash card, or may be remote to the device configuration, such as a computer, a smart-phone, a slate or a tablet.

### CONCLUSION

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described examples of the invention can be implemented in any of numerous ways. For example, some examples may be implemented using hardware, software or a combination thereof. When any aspect of an example is implemented at least in part in software, the software code can be executed on any suitable processor or collection of processors, whether provided in a single device or computer or distributed among multiple devices/computers.

In this respect, various aspects of the invention, may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various examples of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this example, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various examples.

Also, the technology described herein may be embodied as a method, of which at least one example has been provided. The acts performed as part of the method may be ordered in any suitable way. Accordingly, examples may be constructed in which acts are performed in an order different than illustrated, which may include performing some acts simultaneously, even though shown as sequential acts in illustrative examples.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one example, to A only (optionally including elements other than B); in another example, to B only (optionally including elements other than A); in yet another example, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one example, to at least one, optionally including more than one, A, with no B present (and optionally including elements other than B); in another example, to at least one, optionally including more than one, B, with no A present (and optionally including elements other than A); in yet another example, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All examples that come within the spirit and scope of the following claims and equivalents thereto are claimed.

What is claimed is:

1. A system for monitoring a force acting on a foot or a footwear, comprising:
an assembly disposed proximate to a region of the foot or the footwear, the assembly comprising:
a sensing device comprising a single accelerometer, wherein the sensing device is disposed on a flexible substrate or a stretchable substrate, wherein the sensing device conforms to the region of the foot or the footwear, and wherein the sensing device is used to measure data relating to a force acting on the foot or the footwear; and
a processor communicatively coupled to the sensing device, wherein the processor executes processor-executable instructions to analyze the data from the sensing device, and wherein the analysis provides an indication of a location of action of the measured force at a plurality of locations of the foot or the footwear.

2. The system of claim 1, wherein the accelerometer is a triple-axis accelerometer, wherein measuring the data relating to the force, and wherein the processor-executable instructions comprise instructions to compute a projection of the measurement of the accelerometer at the plurality of locations.

3. The system of claim 1, wherein the sensing device is a low-G accelerometer, wherein the processor further executes processor-executable instructions to compute data relating to the force acting on the foot or the footwear that is not measured using the low-G accelerometer.

4. The system of claim 3, wherein the processor-executable instructions comprise instructions to perform a linear interpolation or a curve fitting to compute data relating to the force acting on the foot or the footwear that is not measured using the low-G accelerometer.

5. The system of claim 3, wherein the sensing device is a low-G, triple-axis accelerometer, and wherein the processor-executable instructions comprise instructions to perform a linear interpolation or a curve fitting to compute data relating to the force acting on the foot or the footwear that is not measured using the low-G, triple-axis accelerometer.

6. The system of claim 1, further comprising a gyroscope, wherein the gyroscope measures data relating to at least one of a location of action of the force and a magnitude of the force on the foot or footwear.

7. The system of claim 6, wherein the processor further executes processor-executable instructions to analyze the data from the gyroscope, and wherein the analysis provides an indication of at least one of the location of action of the force and the magnitude of the force.

8. The system of claim 6, wherein the gyroscope is used to measure an angular rotation of the foot or footwear based on the action of the force, and wherein the processor-executable instructions comprise instructions to analyze the data to provide an indication of whether the force is acting at a heel region or a toe region of the foot or footwear.

9. The system of claim 1, further comprising a transmitter, wherein the transmitter transmits to a display the indication of the location of action of the measured force at the plurality of locations of the foot or the footwear.

10. The system of claim 9, wherein the transmitter further transmits the data from the sensing device to the display, wherein a processor associated with the display executes processor-executable instructions to analyze the data from the sensing device and the indication of the location of action of the measured force at the plurality of locations of the foot or the footwear, and wherein the analysis provides an additional indication of the location of action of the measured force at the plurality of locations of the foot or the footwear.

11. The system of claim 1, further comprising a memory communicatively coupled to the processor to store at least one of the processor-executable instructions, the measured data relating to the force acting on the foot or the footwear, and the indication of the location of action of the measured force at the plurality of locations of the foot or the footwear.

12. The system of claim 1, further comprising a display to display the indication of the location of action of the measured force at the plurality of locations of the foot or the footwear, and wherein the display is a screen of a hand-held device, a liquid crystal display, a screen of a computing device, or a light emitting diode.

13. The system of claim 1, further comprising at least one flexible and/or stretchable interconnect to couple the sensing device to the processor.

14. A system for monitoring a force acting on a foot or a footwear, comprising:
an assembly disposed proximate to a region of the foot or the footwear, the assembly comprising:
an array of conformal sensing devices, wherein the array of conformal sensing devices conforms to the region of the foot or the footwear, and wherein the array of conformal sensing devices is used to measure data relating to a force acting on the foot or the footwear; and
a processor communicatively coupled to at least one of the conformal sensing devices of the array, wherein the processor executes instructions to analyze the data from the conformal sensing devices, and wherein the analysis provides an indication of the measured force.

15. The system of claim 14, wherein the processor executes processor-executable instructions to compute data relating to a magnitude of the force acting on the foot or the footwear.

16. The system of claim 14, further comprising a transmitter to transmit the data from the sensing device to a display, wherein a processor of the remote display executes processor-executable instructions to analyze the data from the sensing device, and wherein the analysis provides an additional indication of the measured force.

17. The system of claim 14, further comprising a transmitter, wherein the transmitter transmits to a display the indication of the measured force.

18. The system of claim 17, wherein the transmitter further transmits the data from the sensing device to the display, wherein a processor associated with the display executes processor-executable instructions to analyze the data from the sensing device and the indication of the measured force, and wherein the analysis provides an additional indication of the measured force.

19. The system of claim 14, further comprising a memory communicatively coupled to the processor to store at least one of the processor-executable instructions, the measured data relating to the force acting on the foot or the footwear, and the indication of the measured force.

20. The system of claim 14, further comprising a display to display the indication of the measured force, and wherein the display is a screen of a hand-held device, a liquid crystal display, a screen of a computing device, or a light emitting diode.

21. The system of claim 13, further comprising at least one flexible and/or stretchable interconnect to couple at least one conformal sensing device of the array of conformal sensing devices to the processor.

22. A system for monitoring a force acting on a foot or a footwear, comprising:
an assembly disposed proximate to a region of the foot or the footwear, the assembly comprising:
a sensing device comprising a pressure sensitive rubber, wherein the sensing device conforms to the region of the foot or the footwear, and wherein the sensing device is used to measure data relating to a force acting on the foot or the footwear; and
a processor communicatively coupled to the sensing device, wherein the processor executes processor-executable instructions to analyze the data from the pressure sensitive rubber, and wherein the analysis provides an indication of the measured force.

23. The system of claim 22, wherein the analysis provides an indication of at least one of a location of action of the force and a magnitude of the force.

24. The system of claim 23, wherein the processor-executable instructions comprise instructions to compare the measured data to a calibration standard.

25. The system of claim 24, wherein the calibration standard is generated by applying a plurality of known forces to a plurality of locations around a modeled foot or footwear, measuring the response of the sensing device to the known forces, and correlating values of the known magnitude of the known forces to the measured response of the sensing device.

26. The system of claim 22, further comprising a transmitter to transmit the measured data to a display, wherein a processor of the remote display executes processor-executable instructions to further analyze the data from the sensing device, and wherein the further analysis provides an additional indication of the measured force.

27. The system of claim 22, further comprising a transmitter, wherein the transmitter transmits to a display the indication of the measured force.

28. The system of claim 27, wherein the transmitter further transmits the data from the sensing device to the display, wherein a processor associated with the display executes processor-executable instructions to analyze the data from the sensing device and the indication of the measured force, and wherein the analysis provides an additional indication of the measured force.

29. The system of claim 22, further comprising a memory communicatively coupled to the processor to store at least one of the processor-executable instructions, the measured data relating to the force acting on the foot or the footwear, and the indication of the measured force.

30. The system of claim 22, further comprising a display to display the indication of the measured force, and wherein the display is a screen of a hand-held device, a liquid crystal display, a screen of a computing device, or a light emitting diode.

31. The system of claim 22, further comprising at least one flexible and/or stretchable interconnect to couple the sensing device to the processor.

32. A system for monitoring a force acting on a foot or a footwear, comprising:
an assembly disposed proximate to a region of the foot or the footwear, the assembly comprising:
a sensing device comprising an array of touch elements, wherein the sensing device conforms to the region of the foot or the footwear, and wherein the sensing device is used to measure data relating to a force acting on the foot or the footwear; and
a processor communicatively coupled to at least one of the touch elements of the array, wherein the processor executes processor-executable instructions to analyze the data from the touch elements, and wherein the analysis provides an indication of the measured force.

33. The system of claim 32, wherein the analysis provides an indication of at least one of a location of action of the force and a magnitude of the force.

34. The system of claim 32, further comprising a transmitter to transmit the measured data to a display, wherein a processor of the remote display executes processor-executable instructions to further analyze the data from the sensing device, and wherein the analysis provides an additional indication of the measured force.

35. The system of claim 32, further comprising a transmitter, wherein the transmitter transmits to a display the indication of the measured force.

36. The system of claim 35, wherein the transmitter further transmits the data from the sensing device to the display, wherein a processor associated with the display executes processor-executable instructions to analyze the data from the sensing device and the indication of the measured force, and wherein the analysis provides an additional indication of the measured force.

37. The system of claim 32, further comprising a memory communicatively coupled to the processor to store at least one of the processor-executable instructions, the measured data relating to the force acting on the foot or the footwear, and the indication of the measured force.

38. The system of claim 32, further comprising a display to display the indication of the measured force, and wherein the display is a screen of a hand-held device, a liquid crystal display, a screen of a computing device, or a light emitting diode.

39. The system of claim 32, further comprising a display, wherein the processor executes processor-executable instructions to cause the display to display the indication of the measured force.

40. The system of claim 32, further comprising at least one flexible and/or stretchable interconnect to couple at least one touch element of the array of touch elements to the processor.

41. An insert for a footwear comprising a system of claim 1, 14, 22, or 32.

42. An insert of claim 41, wherein the insert is a sock or a sticker.

43. A footwear comprising at least one system of claim 1, 14, 22, or 32, wherein the sensing device is used to measure a force during the course of a physical therapy, an occupational therapy, a military activity, a biomechanics measurement, or an industrial activity.

44. A system for monitoring a force acting on a foot or a footwear, comprising:
an assembly disposed proximate to a region of the foot or the footwear, the assembly comprising:
a sensing device comprising a single accelerometer, wherein the sensing device is used to measure data relating to a force acting on the foot or the footwear; and
a processor communicatively coupled to the sensing device, wherein the processor executes processor-executable instructions to analyze the data from the sensing device, and wherein the analysis provides an indication of a location of action of the measured force at a plurality of locations of the foot or the footwear.

45. The system of claim 44, wherein the accelerometer is a triple-axis accelerometer, wherein measuring the data relating to the force, and wherein the processor-executable instructions comprise instructions to compute a projection of the measurement of the accelerometer at the plurality of locations.

46. The system of claim 44, wherein the sensing device is a low-G accelerometer, wherein the processor further executes processor-executable instructions to compute data relating to the force acting on the foot or the footwear that is not measured using the low-G accelerometer.

47. The system of claim 46, wherein the processor-executable instructions comprise instructions to perform a linear interpolation or a curve fitting to compute data relating to the force acting on the foot or the footwear that is not measured using the low-G accelerometer.

48. The system of claim 46, wherein the sensing device is a low-G, triple-axis accelerometer, and wherein the processor-executable instructions comprise instructions to perform a linear interpolation or a curve fitting to compute data relating to the force acting on the foot or the footwear that is not measured using the low-G, triple-axis accelerometer.

49. The system of claim 45, further comprising a gyroscope, wherein the gyroscope measures data relating to at least one of a location of action of the force and a magnitude of the force on the foot or footwear.

50. The system of claim 49, wherein the processor further executes processor-executable instructions to analyze the data from the gyroscope, and wherein the analysis provides an indication of at least one of the location of action of the force and the magnitude of the force.

51. The system of claim 49, wherein the gyroscope is used to measure an angular rotation of the foot or footwear based on the action of the force, and wherein the processor-executable instructions comprise instructions to analyze the data to provide an indication of whether the force is acting at a heel region or a toe region of the foot or footwear.

52. The system of claim 44, further comprising a transmitter, wherein the transmitter transmits to a display the indication of the location of action of the measured force at the plurality of locations of the foot or the footwear.

53. The system of claim 52, wherein the transmitter further transmits the data from the sensing device to the display, wherein a processor associated with the display executes processor-executable instructions to analyze the data from the sensing device and the indication of the location of action of the measured force at the plurality of locations of the foot or the footwear, and wherein the analysis provides an additional indication of the location of action of the measured force at the plurality of locations of the foot or the footwear.

54. The system of claim 44, further comprising a memory communicatively coupled to the processor to store at least one of the processor-executable instructions, the measured data relating to the force acting on the foot or the footwear, and the indication of the location of action of the measured force at the plurality of locations of the foot or the footwear.

55. The system of claim 44, further comprising a display to display the indication of the location of action of the measured force at the plurality of locations of the foot or the footwear, and wherein the display is a screen of a hand-held device, a liquid crystal display, a screen of a computing device, or a light emitting diode.
